(19) United States
(12) Patent Application Publication
(10) Pub. No.: US 2008/0195832 A1
(43) Pub. Date: Aug. 14, 2008

(54) Storage controller and storage system

(75) Inventors: Ryu Takada, Odawara (JP); Yoshihito Nakagawa, Ooi (JP); Shinichi Nakayama, Chigasaki (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/007,163

(22) Filed: Jan. 7, 2008

(30) Foreign Application Priority Data
Feb. 13, 2007 (JP) 2007-031569

(51) Int. Cl. G06F 12/06

(52) U.S. Cl. 711/171; 711/E12.078

(57) ABSTRACT

A storage controller of the present invention writes data to a storage device, in which the storage unit is fixed, at a size that is larger than this storage unit, and curbs response performance degradation. A host sends write-data in a prescribed number of logical blocks in accordance with a basic I/O size defined at initialization. A controller respectively creates a guarantee code for each logical block, and appends same to the write-data. Write-data, to which a guarantee code has been appended, is stored in another prescribed number of logical blocks in accordance with a basic disk access size which is set at a value corresponding to the basic I/O size, and sent to a storage device. When an unused part is also stored in the storage device, the utilization efficiency of the storage area decreases, but the need to read out data located before and after data targeted for updating at data write is eliminated, thereby curbing the degradation of response performance.

### CROSS-REFERENCE TO RELATED APPLICATIONS

This application relates to and claims priority from Japanese Patent Application No. 2007-31569 filed on Feb. 13, 2007, the entire disclosure of which is incorporated herein by reference.

### BACKGROUND OF THE INVENTION

1. Field of the Invention

The present invention relates to a storage controller and a storage system.

2. Description of the Related Art

A disk array system is known as a type of storage controller or storage system, which is connected to a server computer, mainframe machine or other such host computer (hereinafter “host”). A disk array system is also called RAID (Redundant Array of Inexpensive Disks), and, for example, comprises a plurality of disk drives arranged in an array, and a controller for controlling these disk drives.

In a disk array system, a data read request and a data write request can be processed at high speed by operating the plurality of disk drives in parallel. Further, for example, it is also possible to add redundancy to data in a disk array system, as is known in RAID1 through RAID5 (D. Patterson and two others: “A Case for Redundant Arrays of Inexpensive Disks (RAID),” ACM SIGMOD Conference Proceeding, June 1988, pp. 109-116).

Thus, in a disk array system, redundant data is created, and this redundant data is stored in a different disk drive than the data so that the data can be recovered even if a disk drive should fail.

In addition to a RAID configuration, a disk array system that makes use of a guarantee code is also known (Japanese Patent Laid-open No. 2000-347815, U.S. Pat. No. 5,819,054, and U.S. Pat. No. 5,706,298). One prior art respectively adds to a logical block a logical address (hereinafter, “LA (Logical Address)”) of a logical block, which specifies a host computer as an access destination, and a LRC (Longitudinal Redundancy Check), which is determined by implementing an exclusive logical OR operation for the data of a logical block, and stores this guarantee code and logical block in a disk drive. LA is used for detecting an error in a storage area address into which logical block data is written. LRC is used as an error detection code for detecting an error in logical block data.

When the above-mentioned guarantee codes are appended to a logical block, there is the possibility that the data amount unit handled by a storage controller, and the data amount unit handled by a storage device will differ. For example, a storage device, in which the block length (sector length) is fixed, as in an ATA (AT Attachment) disk, stores data of a prescribed size in a logical block unit. When a guarantee code is appended to the logical block, the amount of data in the logical block increases by the size of the guarantee code, so that the storage device format may not be able to store the guarantee code-appended logical block.

Accordingly, to solve for this problem, in a fourth literature (Japanese Patent Laid-open No. 2006-195851) there is proposed a technology, which fixes the lowest common multiple of the size of the logical block and the size of the guarantee code-appended logical block as a value for inputting/outputting data to/from a storage device.

As described in the above-mentioned fourth literature, by setting the lowest common multiple of the logical block size and the guarantee code-appended logical block size as a basic unit when the storage controller writes data to a storage device, a logical block appended with a guarantee code can be written to a storage device with a fixed sector length.

For example, if it is supposed that the size of a logical block is 512 bytes, and the size of a guarantee code is 8 bytes, the size of a guarantee code-appended logical block becomes 520 bytes. The lowest common multiple of 512 bytes and 520 bytes is 33280 bytes. In accordance with the storage controller assigning an 8-byte guarantee code to each of 64 logical blocks received from a higher-level device, the total data size becomes 33280 bytes. This value is equivalent to the size of a 65^{th} logical block. Therefore, the 64 guarantee code-appended logical blocks can be stored collectively in a storage device as 65 logical blocks.

However, in the method described in the above-mentioned fourth literature, it is necessary to create 33280 bytes worth of data and send it to the storage device even when a smaller amount of data is to be updated. That is, in the method described in the above-mentioned fourth literature, when writing in a small amount of write-data, it is necessary to read 33280 bytes of data from the storage device, merge this read-out data with the write-data, and write it into the storage device. Thus, write efficiency declines with the method described in the above-mentioned fourth literature.

### SUMMARY OF THE INVENTION

With the foregoing in view, an object of the present invention is to provide a storage controller and storage system constituted so as to be able to write data to a storage device while curbing response performance degradation, even when the size used to transfer data back-and-forth to a higher-level device differs from the size used to transfer data back-and-forth to the storage controller. Another object of the present invention is to provide a storage controller and storage system constituted so as to be able to enhance reliability by using a guarantee code, and to curb performance degradation during a data write, even when the data management unit used in data input/output processing inside the storage controller differs from the data management unit stored inside a storage device. Yet other objects of the present invention should become clear from the description of the embodiments hereinbelow.

To solve for the above-mentioned problems, a storage controller, which conforms to one aspect of the present invention, and which carries out data input/output between a higher-level device and at least one or more storage devices, comprises a first communication channel for sending and receiving data to and from a higher-level device using a first size, which is fixed at a preset value; a second communication channel for sending and receiving data to and from a higher-level device using a second size, which is fixed at a value corresponding to the first size; and a controller for controlling data input/output between a higher-level device and a storage device, which is connected via the first communication channel to the higher-level device and is connected via the second communication channel to the storage device. Furthermore, this controller comprises at least (1) a write function, which converts first size data received via the first communication channel from the higher-level device to second size data, sends this converted second size data to the storage device via the second communication channel, and stores same in the storage device; and (2) a read function, which converts the second size data read from the storage device via the second communication channel to the first size data, and sends this converted first size data to the higher-level device via the first communication channel.

In an embodiment of the present invention, the first size and second size can be respectively depicted as the number of first blocks having a prescribed size, the number of first blocks having the first size can be arbitrarily set within a range that is not less than one but not more than a prescribed maximum value, and the number of first blocks having the second size is set greater by one than the number of first blocks having the first size.

In an embodiment of the present invention, when the number of first blocks having the first size is set at under the prescribed maximum value, the final first block of the plurality of first blocks having the second size comprises an area that is not used.

In an embodiment of the present invention, a prescribed maximum value (Nmax) is set as a value (Nmax=LCM (BS1, BS2)/BS1−1), arrived at by subtracting 1 from a value (LCM (BS1, BS2)/BS1) obtained by dividing the lowest common multiple (LCM (BS1, BS2)) of a prescribed size of a first block (BS1) and of another prescribed size, which appends a prescribed redundancy data size (RDS) to a first block (BS2=BS1+RDS), by a prescribed size (BS1).

In an embodiment of the present invention, when there are a plurality of storage devices, the controller respectively sets the first size and the second size in each of the plurality of storage devices.

In an embodiment of the present invention, there is provided on the storage device side a data placement conversion unit for providing data, which is stored in second size units in a storage device by converting to the placement when data is stored in first size units.

In an embodiment of the present invention, the controller further comprises a function for storing a second size value in a prescribed location inside a storage device.

In an embodiment of the present invention, the controller further comprises a function, which, when the controller and a storage device are connected via the second communication channel, detects a second size value related to data stored in a storage device by reading out a prescribed amount of data stored in the storage device while changing the value of the read-out size, and examining the contents of the read-out data.

In an embodiment of the present invention, the value of a first size is decided by a higher-level device.

In an embodiment of the present invention, the value of a second size is decided by a storage device.

In an embodiment of the present invention, when a first size value decided by a higher-level device and a second size value decided by a storage device do not correspond to one another, all of the data stored in the storage device is read out, a value corresponding to the first size value decided by the higher-level device is set as the second size value, and all the read-out data is written back into the storage device in units of this set second size.

In an embodiment of the present invention, the controller can create for data received from a higher-level device, a second block, which is larger in size than a first block, by respectively appending redundancy data of a prescribed size to each pre-set first block size, and the controller determines whether a storage device stores data in first block units, or whether the storage device stores data in second block units, and (1) when the storage device stores data in first block units, sends second size data obtained by converting first size data to the storage device using first blocks, and (2) when the storage device stores data in second block units, sends second size data obtained by converting first size data to the storage device using second blocks.

A storage system, which conforms to another aspect of the present invention, comprises a controller, which is connected to a higher-level device via a first communication channel, and which process a request from the higher-level device; and a storage device, which is connected to the controller via a second communication channel, and which is controlled by the controller, and (1) the higher-level device and controller are set so as to send and receive data by using only a pre-set first prescribed number of first blocks utilized in sending and receiving data, (2) the controller and storage device are set so as to send and receive data using a second prescribed number of first blocks, which is set at a value that is greater by one than the first prescribed number, (3) the controller (3-1) receives a first prescribed number of first blocks worth of data from the higher-level device via the first communication channel, (3-2) appends a prescribed redundancy data to the received data for each first block, and creates second block unit data, which is larger in size than the first block, (3-3) stores the created second block unit data by dividing same into a second prescribed number of first blocks, and (3-4) sends the second prescribed number of first blocks to the storage device via the second communication channel, and stores same in the storage device.

In an embodiment of the present invention, a higher-level device sets a first prescribed number at a value that is suitable for the higher-level device.

In an embodiment of the present invention, a plurality of storage devices are provided as the storage device, and a second prescribed number can be associated to the plurality of storage devices using respectively different values.

At least a portion of either the respective units or respective steps of the present invention may be constituted as a computer program. This computer program can be distributed by affixing it to a recording medium, or it can be distributed via a network.

### BRIEF DESCRIPTION OF THE DRAWINGS

FIG. 1 is a schematic diagram showing an overall concept of an embodiment of the present invention;

FIG. 2 is a block diagram showing an overall constitution of a storage system according to an embodiment of the present invention;

FIG. 3 is a diagram schematically showing a virtualization function in accordance with a main storage apparatus;

FIG. 4 is a diagram schematically showing essential elements of a storage system software configuration;

FIG. 5 is a schematic diagram showing configuration information;

FIG. 6 is a schematic diagram showing the relationship between a basic I/O size and a basic disk access size;

FIG. 7 is a diagram schematically showing the change in utilization efficiency of a disk drive when the basic I/O size is changed;

FIG. 8 is the same schematic diagram as FIG. 7;

FIG. 9 is a flowchart showing the process when a storage system performs initialization;

FIG. 10 is a flowchart for processing a read command;

FIG. 11 is a flowchart for processing a write command;

FIG. 12 is a schematic diagram showing that respectively different basic I/O sizes can be set for each virtual logical volume inside a main storage apparatus;

FIG. 13 is a flowchart showing a process for setting a basic disk access size, which is executed by a storage system related to a second embodiment of the present invention;

FIG. 14 is a schematic diagram showing the relationship between management information inside a disk drive and configuration information inside a main storage apparatus;

FIG. 15 is a schematic diagram showing a constitution of a storage system related to a third embodiment of the present invention;

FIG. 16 is a flowchart show a process for adding yet another guarantee code to guarantee code-appended write data, and writing same to a disk drive;

FIG. 17 is a schematic diagram showing a constitution of a storage system related to a fourth embodiment of the present invention;

FIG. 18 is a schematic diagram showing a constitution of an address conversion unit, and a configuration of a virtual logical volume created by the address conversion unit;

FIG. 19 is a flowchart showing a storage system initialization process executed by a storage system related to a fifth embodiment of the present invention; and

FIG. 20 is a schematic diagram showing a constitution of a storage system related to a sixth embodiment of the present invention.

### DESCRIPTION OF THE PREFERRED EMBODIMENTS

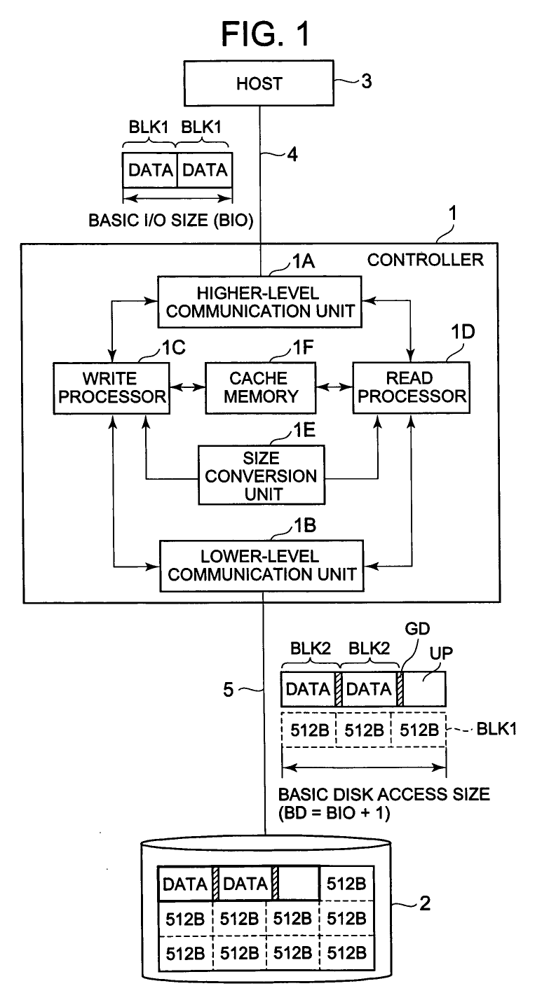

The embodiments of the present invention will be explained below by referring to the figures. First, a concept of the present invention will be explained, and thereafter, the specific embodiments will be explained. FIG. 1 is a diagram schematically showing a concept of the present invention.

A storage system, for example, is constituted comprising a controller 1, a storage device 2, and a host 3. The controller 1 and the host 3 are connected via a first communication channel 4 that enables two-way communications, and the controller 1 and storage device 2 are connected via a second communication channel 5 that enables two-way communications. The first communication channel 4 and the second communication channel 5, for example, are constituted as a SAN (Storage Area Network) network that uses the Fibre Channel Protocol.

The controller 1 carries out control so as to read data from the storage device 2, or write data to the storage device 2 in accordance with a command issued from the host 3. As will become clear from the embodiments explained hereinbelow, for example, a storage apparatus 10, which is equipped with a large number of hard disk drives, can be used as a controller. Or, a Fibre Channel switch can also be used as a controller. The controller 1, for example, is constituted comprising a higher-level communication unit 1A, a lower-level communication unit 1B, a write processor 1C, a read processor 1D, a size conversion unit 1E, and a cache memory 1F.

The higher-level communication unit 1A is connected to the host 3 via the first communication channel 4, and is in charge of sending and receiving data to and from the host 3. The lower-level communication unit 1B is connected to the storage device 2 via the second communication channel 5, and is in charge of sending and receiving data to and from the storage device 2.

The write processor 1C executes write processing for writing to the storage device 2 write-data received from the host 3 in accordance with a write command issued from the host 3. The read processor 1D reads from the storage device 2 data requested by the host 3, and sends the read-out data to the host 3 in accordance with a read command issued by the host 3.

The size conversion unit 1E converts the size of data received from the host 3 (a first size) to a size (a second size) suitable for storing this data in the storage device 2. Further, the size conversion unit 1E can also convert the size of data read out from the storage device 2 from the second size to the first size. Data size conversion will be explained further below.

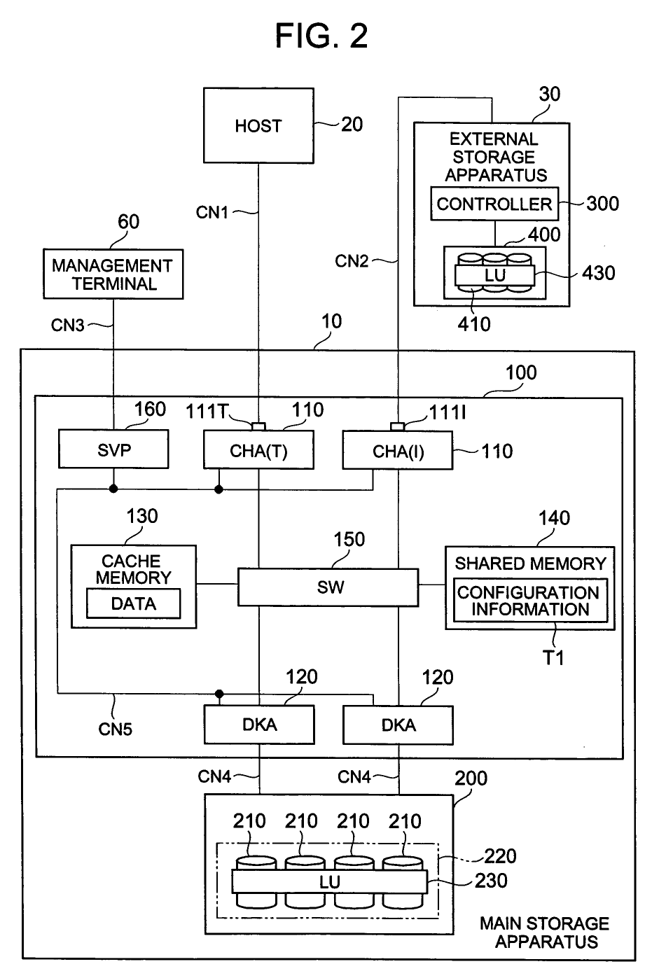

The cache memory 1F is used for temporarily storing write-data received from the host 3, and data read out from the storage device 2. Furthermore, management information and configuration information required by the controller 1 for control can also be stored in either cache memory 1F or another memory not shown in the figure. As will become clear from the embodiments explained hereinbelow, configuration information T1 can also be stored inside a shared memory 140 (Refer to FIG. 2).

The storage device 2, for example, is constituted as a rewritable storage device, such as a hard disk device, semiconductor memory device, flash memory device, optical disk device, or magneto-optical disk device. As will become clear from the embodiments explained hereinbelow, for example, a storage apparatus 30 equipped with a large number of hard disk drives can also be used as a storage device. Here, for convenience of explanation, the present invention will be explained using a hard disk drive as an example. The storage device 2, for example, handles data in units of a fixed size, such as 512 bytes.

A first characteristic feature of this embodiment is that the data size used in exchanging data back and forth between the host 3 and the controller 1 is fixed at the initialization value. The data size used for exchanging data back and forth between the host 3 and the controller 1 is called the basic I/O size (BIO) in the following explanation. I/O is the abbreviation for input/output. The basic I/O size, for example, can be defined in accordance with the nature of the application program executed on the host 3.

A second characteristic feature of this embodiment is that the data size used in exchanging data back and forth between the controller 1 and the storage device 2 is fixed at a value corresponding to the above-mentioned basic I/O size. The data size used for exchanging data back and forth between the controller 1 and the storage device 2 is called the basic disk access size (BD) in the following explanation.

A third characteristic feature of this embodiment is that the basic I/O size is a value, which is suited to the host 3, and which can be arbitrarily selected within a prescribed range. A value that is suited to the host 3, for example, can be defined as a value that corresponds to the unit used when an application program uses the storage device 2 to carry out data input/output processing.

A fourth characteristic feature of this embodiment is that when the maximum value selectable as the basic I/O size is selected, the byte length of the basic disk access size becomes an integral multiple value of the byte length of a logical block, resulting in less of a processing burden on the controller 1 and storage device 2, and enabling the efficiency of the storage system as a whole to be improved to the utmost.

The basic I/O size and basic disk access size can both be expressed as a number of logical blocks of a logical block BLK1 of a prescribed size. The logical block BLK1 is equivalent to a “first block”, and, for example, has a size of 512 bytes.

In the example shown in FIG. 1, the basic I/O size is fixed at the size of two logical blocks BLK1. In this case, since the size of the respective logical blocks BLK1 is 512 bytes, the basic I/O size is 1024 bytes.

The write processor 1C appends redundancy data (GD) to each logical block BLK1 of the basic I/O size write data received from the host 3. This redundancy data is called a guarantee code (GD), and is data for guaranteeing the contents and storage destination of the data of a logical block BLK1. A guarantee code, for example, comprises a logical address showing the location where the data of the logical block BLK1 thereof is to be stored, and an LRC value computed from the data inside this logical block BLK1. A guarantee code, for example, has a size of eight bytes.

Adding an 8-byte guarantee code GD to a 512-byte logical block BLK1 creates an extended logical block BLK2 as a “second block”. The size conversion unit 1E converts the size of the write data received from the host 3 from the basic I/O size to the basic disk access size so as to enable the data of the extended logical block BLK2 to be sent using a plurality of logical blocks BLK1.

When the basic I/O size and basic disk access size are expressed as a number of logical blocks BLK1, the size conversion unit 1E is preset such that the basic disk access size BD becomes a number of logical blocks BLK1 that is just one larger than the basic I/O size BIO. In the example of the figure, since the basic I/O size BIO comprises two logical blocks BLK1, the basic disk access size BD will become the size of three logical blocks BLK1.

As shown in the bottom of FIG. 1, the write-data originally received by the controller 1 as two logical blocks BLK1 is sent to the storage device 2 from the controller 1 using three logical blocks BLK1. Therefore, the basic disk access size BD, which is made up of three logical blocks BLK1, comprises two logical blocks BLK1 worth of write-data (total of 1024 bytes), guarantee codes GD assigned to each logical block BLK1 (total of 16 bytes), and an unused part UP (512×3−(1024+16) 496 bytes).

The unused part UP is an unused area for making the logical blocks BLK1 and extended logical blocks BLK2 consistent. For example, the value “0” can be stored in the unused part UP. Adding an unused part UP at the end of a plurality of extended logical blocks BLK2 makes it possible to write write-data into the storage device 2 using a logical block BLK1 of an integral value.

As described hereinabove, the storage device 2 handles data in logical block BLK1 units. Then, in this embodiment, since an extended logical block BLK2, the size of which is larger by the guarantee code GD portion, is stored in the storage device 2, the storage unit of which is fixed at a logical block BLK1, the unused part UP is used to adjust the size of the write-data to an integral multiple of a logical block BLK1. The number of logical blocks BLK1 constituting the basic disk access size BD becomes greater by one than the number of logical blocks BLK1 constituting the basic I/O size BIO.

The number of logical blocks BLK1 constituting the basic I/O size BIO can be set at an arbitrary value in accordance with the convenience of the host 3. The basic I/O size BIO must comprise one logical block BLK1 at the minimum.

The maximum value Nmax of the number of logical blocks BLK1 constituting a basic I/O size BIO is defined as a value (Nmax=LCM (BS1, BS2)/BS1−1), arrived at by subtracting 1 from a value (LCM (BS1, BS2)/BS1) achieved by dividing the lowest common multiple (LCM (BS1, BS2)) of a the byte length of a logical block BLK1 (BS1=512 bytes) and the byte length of an extended logical block BLK2 (BS2=520 bytes) by the byte length BS1 of the logical block BLK1.

That is, making the byte length of the basic I/O size BIO and the byte length of the basic disk access size BD coincide with the lowest common multiple of the byte length of a logical block BLK1 and the byte length of an extended logical block BLK2 can completely do away with the unused part UP inside the write-data written to the storage device 2.

More specifically, because the byte length of a logical block BLK1 is 512 bytes, and the byte length of an extended logical block BLK2 is 520 bytes, the lowest common multiple of 512 bytes and 520 bytes is 33280 bytes. Dividing this lowest common multiple of 33280 bytes by 512 bytes results in a quotient of 65. That is, the basic disk access size BD can be constituted from a maximum of 65 logical blocks BLK1. The maximum number (Nmax) of logical blocks BLK1 constituting the basic I/O size BIO becomes 64 (=65−1). This is to deduct the total number of bytes of the guarantee codes (GD) appended to each of the 64 logical blocks BLK1 (8×64=512).

Thus, in this embodiment, data to which a guarantee code has been appended can be stored in the storage device 2 for which the unit for storing data is fixed at 512 bytes. In other words, in this embodiment, the data management unit utilized in the storage space inside the controller 1 is converted to a data management unit utilized in the storage space inside the storage device 2.

When the byte length of the basic I/O size BIO coincides with the byte length of the basic disk access size BD, an unused part UP is not created inside the data written to the storage device 2. Otherwise, a number of unused parts UP are created inside the data written to the storage device 2. In other words, when the number of logical blocks BLK1 constituting the basic I/O size BIO is less than 64, the write-data sent to the storage device 2 from the controller 1 comprises an unused part UP.

The ratio of the unused part UP to the write-data stored in the storage device 2 decreases proportionally as the number N of logical blocks BLK1 constituting the basic I/O size BIO increases, and becomes 0 when N is 64. In other words, the greater the number of logical blocks BLK1 constituting the basic I/O size BIO, the smaller the size of the unused part UP inside the write data stored in the storage device 2, making it possible to effectively use the storage capacity of the storage device 2.

In this embodiment, wasted area may be generated inside the storage device 2 by the unused part UP, but the characteristic constitution of this unused part UP makes it possible to send write-data to which a guarantee code has been appended to the storage device 2 as logical block BLK1 unit data. Therefore, in this embodiment, a guarantee code can guarantee the reliability of write-data, and can do away with a write penalty, thereby curbing response performance degradation.

As already mentioned, when the access size between the controller 1 and the storage device 2 is fixed at the lowest common multiple of the logical block BLK1 and the extended logical block BLK2, updating data of a size that does not meet the lowest common multiple requires that the data before and after the update locations be read out from the storage device 2, thereby decreasing response performance. By contrast, in this embodiment, adding an unused part UP at the end of a group of extended logical blocks BLK2 makes it possible to match both ends of write data sent to the storage device 2 from the controller 1 to the boundaries of the respective physical blocks inside the storage device 2 (that is, sector sizes equivalent to logical blocks BLK1).

In this embodiment, the host 3 can fix the basic I/O size BIO when accessing the storage device 2 to a value that is suited to the host 3. A user can select the basic I/O size BIO at storage system construction by comprehensively taking into account the utilization efficiency of the storage system 2 and the circumstances of the host 3. The basic disk access size BD is automatically determined on the basis of the basic I/O size BIO. Consequently, it is possible to curb the degradation of response performance and improve the usability of a storage system that utilizes a guarantee code.

As will also become clear from the embodiments explained hereinbelow, a basic I/O size BIO can be set for each volume. That is, the basic I/O size BIO can be set at arbitrary values comprising various prescribed ranges for each disk drive constituting the respective volumes. Therefore, for example, a basic I/O size BIO and basic disk access size BD can be set in accordance with the type of application program being executed on the host 3. This embodiment will be explained in detail below.

### First Embodiment

FIG. 2 is a schematic diagram showing an overall constitution of a storage system related to this embodiment. This storage system, for example, can be constituted comprising at least one main storage apparatus 10, one or a plurality of hosts 20, one or a plurality of external storage apparatuses 30, and at least one management terminal 60. This storage system, for example, is utilized at various types of companies, universities and government organizations. However, this storage system is not limited thereto, and can also be used in the home.

First, the corresponding relationship between FIGS. 1 and 2 will be explained. The controller 100 of the main storage apparatus 10 corresponds to the controller 1 in FIG. 1, the host 20 corresponds to the host 3 in FIG. 1, the external storage apparatus 30 and/or the storage unit 200 correspond to the storage device 2 in FIG. 1, the communication channel CN1 corresponds to the communication channel 4 in FIG. 1, and the communication channel CN2 corresponds to the communication channel 5 in FIG. 1. The channel adapter 110 of the one side (CHA (T) in the figure) corresponds to the higher-level communication unit 1A in FIG. 1. The channel adapter 110 of the other side (CHA (I) in the figure) and/or the disk adapter 120 correspond to the lower-level communication unit 1B in FIG. 1.

The host 20 and the main storage apparatus 10, for example, are connected via a communication channel CN1 such as a SAN to enable two-way communications. The host 20, for example, is constituted as a computer device, such as a server computer, mainframe computer, workstation or the like. When the host 20 is a mainframe computer, for example, data transfer is carried out in accordance with a communication protocol such as FICON (Fibre Connection: registered trademark), ESCON (Enterprise System Connection: registered trademark), ACONARC (Advanced Connection Architecture: registered trademark), FIBARC (Fibre Connection Architecture: registered trademark) or the like.

The main storage apparatus 10 serves the role of centrally managing the storage resources inside the storage system. As will be explained hereinbelow, the main storage apparatus 10 comprises functions for virtualizing the physical storage resources scattered inside the storage system, and providing same to the host 20. That is, the main storage apparatus 10 makes it appear to the host 20 as if the storage resources inside an external storage apparatus 30 are actually storage resources inside the main storage apparatus 10. Thus, the main storage apparatus 10 comprises an aspect as a virtualization apparatus for virtualizing storage resource scattered around inside the storage system. Focusing on this aspect, the main storage apparatus 10 does not necessarily have to be constituted as a disk array device, and, for example, can also be constituted from another device such as a Fibre Channel switch.

The constitution of the main storage apparatus 10 will be explained. The main storage apparatus 10 can be broadly divided into a controller 100 and a storage unit 200. The constitutions of the controller 100 and the storage unit 200 will each be explained hereinbelow. Simply stated, the controller 100 is for controlling the operation of the main storage apparatus 10. The storage unit 200 is for housing a plurality (normally a large number) of disk drives 210. The controller 100 and storage unit 200 can be disposed inside the same enclosure, or they can also be disposed inside respectively different enclosures. Further, the constitution can also be such that the controller 100 can be disposed inside one or a plurality of enclosures, a plurality of disk drives 210 can respectively be disposed inside another one or a plurality of enclosures, and these respective enclosures can be connected by a communication channel in accordance with the Fibre Channel Protocol.

The constitution of the controller 100 will be explained. The controller 100, for example, is constituted comprising at least one or more channel adapters (hereinafter, CHA) 110, at least one or more disk adapters (hereinafter, DKA) 120, at least one or more cache memories 130, at least one or more shared memories 140, a connector (“SW” in the figure) 150, and a service processor (hereinafter, SVP) 160.

The CHA 110 is for controlling data communications with the host 20, and, for example, is constituted as a computer device comprising a microprocessor and a local memory. The respective CHA 110 comprise at least one or more communication ports 111. Identification information, such as, for example, WWN (World Wide Name), is set in a communication port 111. When the host 20 and main storage apparatus 10 carry out data communications using iSCSI (Internet Small Computer Systems Interface), identification information such as an IP (Internet Protocol) address and so forth is set in a communication port 111.

In FIG. 2, two types of CHA 110 are shown. The one CHA 110, which is located on the left side of FIG. 2, is for receiving and processing a command from the host 20, and the communication port 111(T) thereof is the target port. The other CHA 110, which is located on the right side of FIG. 2, is for issuing a command to the external storage apparatus 30, and the communication port 111(I) thereof is the initiator port.

The DKA 120 is for controlling data communications with the respective disk drives 210, and is constituted as a computer device comprising a microprocessor and a local memory the same as the CHA 110.

The respective DKA 120 and the respective disk drives 210, for example, are connected via a communication channel CN4 that conforms to the Fibre Channel Protocol. The respective DKA 120 and the respective disk drives 210 carry out data transfer in block units. The route for the controller 100 to access the respective disk drives 210 is made redundant. If a failure occurs in either the DKA 120 or communication channel CN4 of the one side, the controller 100 can access a disk drive 210 using the DKA 120 and communication channel CN4 of the other side. Similarly, the route between the host 20 and the controller 100, and the route between the external storage apparatus 30 and the controller 100 can also be made redundant. Furthermore, the respective DKA 120 constantly monitor the status of the disk drives 210. The SVP 160 acquires the results of monitoring by the DKA 120 via an internal network CN5.

The respective CHA 110 and respective DKA 120, for example, respectively comprise a printed circuit board on which is mounted a processor and a memory, and a control program stored in the memory, and realize their respective prescribed functions by the collaborative interaction of these hardware and software components. The CHA 110 and DKA 120, together with cache memory 130 and shared memory 140, constitute the controller 100.

The operations of the CHA 110 and DKA 120 will be explained in brief. Detailed operations will be explained while referring to another figure. Upon receiving a read command issued from the host 20, the CHA 110 stores this read command in the shared memory 140. The DKA 120 constantly references shared memory 140, and when it detects an unprocessed read command, the DKA 120 reads data from a disk drive 210 and stores it in the cache memory 130. The CHA 110 reads the data, which has been transferred to the cache memory 130, and sends it to the host 20.

Conversely, upon receiving a write command issued from the host 20, the CHA 110 stores this write command in the shared memory 140. Further, the CHA 110 stores the received write command in the cache memory 130. After storing the write command in the cache memory 130, the CHA 110 reports write-end to the host 20. The DKA 120 read the data, which has been stored in the cache memory 130, and stores same in a prescribed disk drive 210 in accordance with the write command stored in the shared memory 140.

The cache memory 130, for example, is for storing data and so forth received from the host 20. The cache memory 130, for example, is constituted from a nonvolatile memory. The shared memory 140, for example, is constituted from a nonvolatile memory. For example, control information and management information, such as the configuration information T1, is stored in the shared memory 140. The constitution of the configuration information T1 will be explained hereinbelow with another figure.

The shared memory 140 and the cache memory 130 can be disposed together on the same memory board. Or, a portion of memory can be used as a cache area, and the other portion can be used as a control area.

The connector 150 respectively connects the respective CHA 110, the respective DKA 120, the cache memory 130, and the shared memory 140. Consequently, all of the CHA 110 and DKA 120 can respectively access the cache memory 130 and the shared memory 140. The connector 150, for example, can be constituted as a crossbar switch.

The SVP 160 is respectively connected to the respective CHA 110 and the respective DKA 120 via a LAN or other such internal network CN5. Further, the SVP 160 is able to connect to the management terminal 60 via a LAN or other such communication network CN3. The SVP 160 collects various states inside the main storage apparatus 10, and provides same to the management terminal 60. Furthermore, the SVP 160 can be connected to only one of either the CHA 110 or the DKA 120. This is because the SVP 160 is able to collect a variety of status information via the shared memory 140.

The constitution of the controller 100 is not limited to the constitution described hereinabove. For example, the controller 100 can also be constituted so as to respectively provide on either one or a plurality of control boards a function for carrying out data communications with the host 20, a function for carrying out data communications with the external storage apparatus 30, a function for carrying out data communications with a disk drive 210, a function for temporarily storing data, and a function for rewritably storing configuration information T1.

The constitution of the storage unit 200 will be explained. The storage unit 200 comprises a plurality of disk drives 210. The respective disk drives 210, for example, are realized as hard disk drives, flash memory devices, optical disk drives, magneto-optical disk drives, holographic memory devices, and so forth. In brief, the storage unit 200 comprises nonvolatile rewritable storage devices.

RAID configurations and the like will differ, but a parity group 220, for example, is constituted in accordance with a prescribed number of disk drives 210, such as three drives per group, or four drives per group. The parity group 220 virtualizes the physical storage areas of the respective disk drives 210 inside the parity group 220. Therefore, the parity group 220 is a virtualized physical storage device. A logical volume (LU: Logical Unit) 230 of either a prescribed size or a variable size can be set in the physical storage area of the parity group 220. The logical volume 230 is a logical storage device. The logical volume 230 is made correspondent to a LUN (Logical Unit Number), and provided to the host 20.

The external storage apparatus 30, for example, comprises a controller 300 and a storage unit 400, the same as the main storage apparatus 10. A logical volume 430 is provided using either one or a plurality of disk drives 410 of the storage unit 400. The external storage apparatus 30 is called an external storage apparatus because, as viewed from the main storage apparatus 10, it exists outside the main storage apparatus 10. Further, a disk drive 410 of the external storage apparatus 30 may be called an external disk, and a logical volume 430 of the external storage apparatus 30 may be called an external volume.

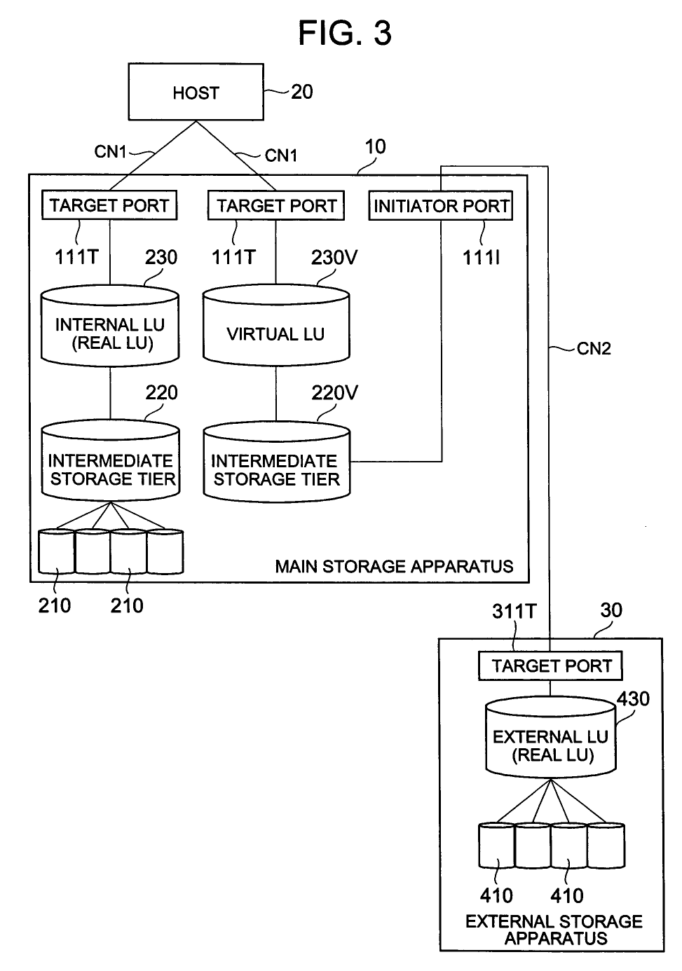

FIG. 3 is a diagram schematically showing a state in which the main storage apparatus 10 virtualizes a storage resource. As described hereinabove, a physical storage area comprising disk drives 210 of the main storage apparatus 10 is virtualized by an intermediate storage tier 220 (that is, a parity group). Either one or a plurality of logical volumes 230 can be disposed in either fixed sizes or variable sizes in the intermediate storage tier 220.

The logical volume 230 shown on the left side of FIG. 3 is an internal real volume because it is created on the basis of the disk drives 210 inside the main storage apparatus 10. Accordingly, this logical volume 230 may simply be called the internal volume in the following explanation. The internal volume 230 is provided to the host 20 via the one target port 111T.

The logical volume 230V shown on the right side of FIG. 3 is a logical volume virtually disposed inside the main storage apparatus 10. This virtual logical volume 230V is connected to the logical volume 430 inside the external storage apparatus 30 via a virtual intermediate storage tier 220V. That is, the virtual intermediate storage tier 220V is a virtual physical storage device, and this entity exists inside the external storage apparatus 30.

The virtual logical volume 230V is provided to the host 20 via the other target port 111T. When a command, which has the virtual logical volume 230V as its access target, is issued from the host 20, the controller 100 confirms the location of the external volume 430 corresponding to the virtual logical volume 230V by referencing the configuration information T1.

The controller 100 converts a command received from the host 20 to a command to be sent to the external storage apparatus 30. The converted command is inputted to the target port 311T of the external storage apparatus 30 from the initiator port 111 via the communication channel CN2. The controller 300 of the external storage apparatus 30 either writes data to the external volume 430, or reads data from the external volume 430 in accordance with the command received from the main storage apparatus 10. Data read out from the external volume 430 is sent to the host 20 by way of the communication channel CN2, intermediate storage tier 220V, virtual logical volume 230V, and communication channel CN1.

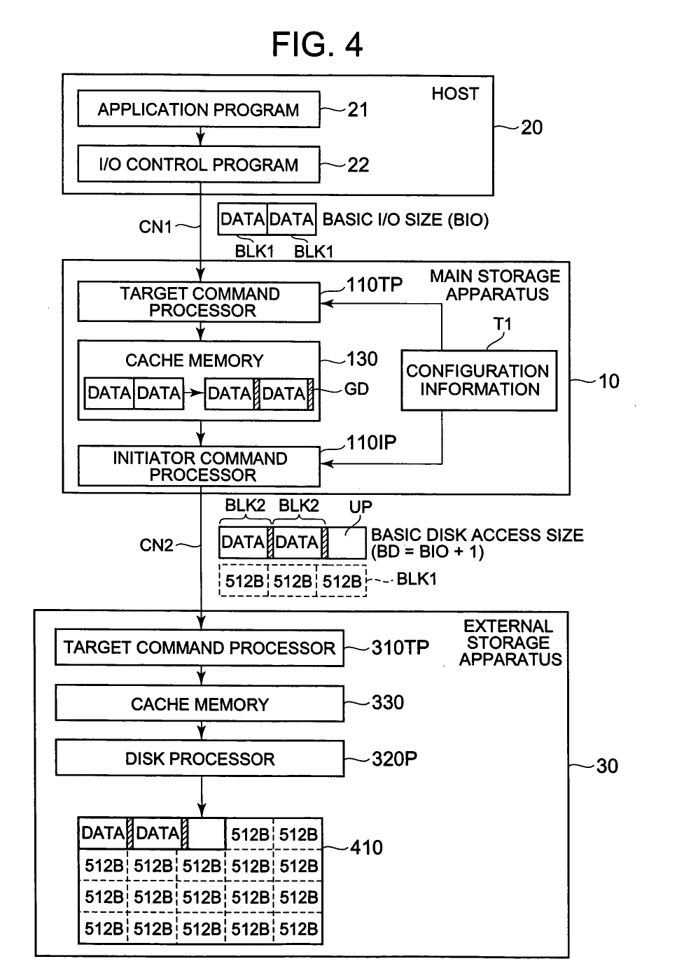

FIG. 4 is a schematic diagram focusing on the software configuration of a storage system. The host 20, for example, can comprise an application program 21, an I/O control program 22, and so forth. For example, an application program 21, such as a database program or the like, utilizes the main storage apparatus 10 by way of the I/O control program 22.

The I/O control program 22 executes a read command or a write command based on a request from the application program 21. The I/O control program 22 issues a write command in accordance with a preset basic I/O size BIO. This basic I/O size BIO can be expressed as a number of logical blocks BLK1.

The main storage apparatus 10, for example, comprises a target command processor 110TP and an initiator command processor 110IP. The target command processor 110TP is executed by the CHA 110 that receives a target command. The initiator command processor 110IP is executed by the CHA 110 that issues an initiator command.

Upon receiving a write command and write-data from the host 20, the target command processor 110TP stores write-data, which is stored in a first prescribed number of logical blocks BLK1, in the cache memory 130.

The initiator command processor 110IP respectively appends a guarantee code GD to each logical block BLK1 of the write-data stored in the cache memory 130. Furthermore, the constitution can be such that the creation of a guarantee code GD and the addition of a created guarantee code GD to a logical block BLK1 are executed by the target command processor 110TP. In this embodiment, the initiator command processor 110IP executes guarantee code creation.

The initiator command processor 110IP creates an extended logical block BLK2 by appending a guarantee code GD to each of the respective logical blocks BLK1. As described hereinabove, the byte length of a logical block BLK1 is 512 bytes, and because the byte length of a guarantee code GD is 8 bytes, the byte length of an extended logical block BLK2 becomes 520 bytes. The initiator command processor 110IP stores write-data in a second prescribed number of logical blocks BLK1 by adding an unused part UP of a prescribed size to the final extended logical block BLK2, and sends same to the external storage apparatus 30. That is, the initiator command processor 110IP makes write-data by using a number of logical blocks BLK1 corresponding to the number of logical blocks BLK1 constituting the basic I/O size BIO. The basic disk access size BD is constituted from a number of logical blocks BLK1 that is one greater than the number of logical blocks BLK1 constituting the basic I/O size BIO.

The external storage apparatus 30, for example, comprises a target command processor 310TP and a disk processor 320P. The target command processor 310TP is for receiving and processing a command issued from the main storage apparatus 10. The disk processor 320P is for accessing the disk drive 410 and writing/reading data to/from the disk drive 410 based on a command issued from the main storage apparatus 10. The disk processor 320P writes write-data stored in the cache memory 330 to the disk drive 410.

Write-data stored in the cache memory 330 may comprise an unused part UP. The disk processor 320P writes the write-data, which comprises an unused part UP, to the disk drive 410. Therefore, as shown at the bottom of FIG. 4, an unused part UP exists in the storage area of the disk drive 410, and the utilization efficiency of the disk drive 410 is degraded by this unused part UP portion. However, in exchange for the disadvantage of the utilization efficiency degradation of the disk drive 410, a guarantee code-appended logical block (an extended logical block BLK2) can be written to the disk drive 410 as-is as an aggregate of logical blocks BLK1. That is, in this embodiment, in exchange for the degradation of utilization efficiency in the disk drive 410, the penalty for writing write-data comprising a guarantee code is lessened.

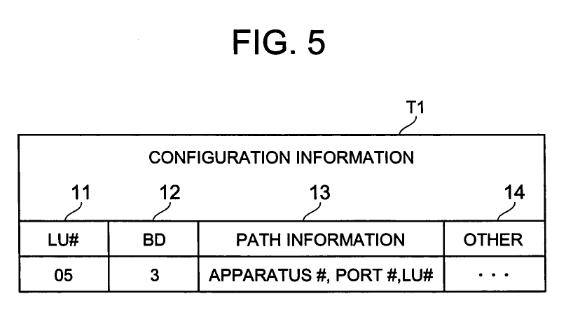

FIG. 5 is a schematic diagram showing configuration information T1. The configuration information T1 is for managing information related to the configuration of a logical volume, and, for example, is stored in the shared memory 140. The configuration information T1, for example, is constituted comprising a logical volume identification number (“LU#” in the figure) I1, a basic disk access size value I2, path information I3, and other information I4.

The logical volume identification number I1 is information for identifying the respective logical volumes 230, 230V. The basic disk access size value I2 manages the value of the basic access size BD corresponding to the respective logical volumes 230, 230V. Furthermore, this value I2 can manage the value of the basic I/O size BIO instead of the value of the basic disk access size BD. Or, this value I2 can respectively manage the value of the basic disk access size BD and the value of the basic I/O size BIO. The path information I3 manages the access channels to either the disk drives 210 or the external volumes 430, which are connected to the respective logical volumes 230, 230V. The other information I4, for example, can comprise information related to the storage capacities of the respective logical volumes 230, 230V, the types of disk drives constituting the respective logical volumes 230, 230V, and hosts 20 capable of accessing the respective logical volumes 230, 230V, and the access levels thereof.

In the case of the internal real volume 230, information related to internal disk drives 210 is stored in the path information I3. For example, the numbers of the respective disk drives 210 constituting this internal volume 230 are stored in the path information I3. In the case of a virtual logical volume 230V, channel information for accessing an external volume 430 corresponding to this virtual logical volume 230V is stored in the path information I3. The channel information, for example, can include the apparatus number for identifying the external storage apparatus 30, the port number for identifying the target port 311T of the external storage apparatus 30, and the volume number for identifying a logical volume 430 inside the external storage apparatus 30.

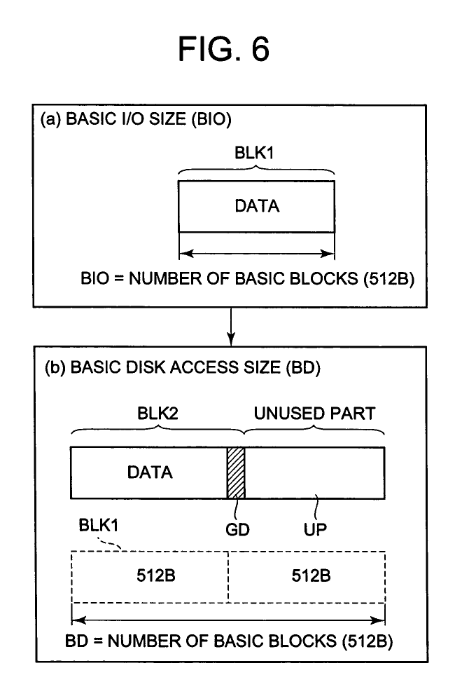

FIG. 6 is a diagram schematically showing the relationship between a logical block BLK1 and an extended logical block BLK2. As already described, the storage system of this embodiment uses a logical block BLK1 as the data transfer unit. A logical block BLK1 has a length of 512 bytes the same as a physical block (sector) inside a disk drive 210, 410.

As shown in FIG. 6 (a), the basic I/O size BIO can be expressed as a number of logical blocks BLK1. The host 20 creates write-data in basic I/O size BIO units having a length of the integral multiple of the byte length of a logical block BLK1, and sends this write-data to the main storage apparatus 10.

As shown in FIG. 6 (b), a guarantee code GD is created and appended to each of the respective logical blocks BLK1 inside the main storage apparatus 10. A logical block BLK1 to which a guarantee code GD is appended becomes an extended logical block BLK2 having a length of 520 bytes. Because the size of an extended logical block BLK2 is larger than that of a logical block BLK1 by the guarantee code GD portion, it cannot be written as-is to a disk drive 210, 410 that stores data in logical block BLK1 units. Accordingly, in this embodiment, the byte length of the write-data is made to coincide with the integral multiple of a logical block BLK1 by adding an unused part UP at the end of the last extended logical block BLK2. In other words, in this embodiment, an unused part UP is added to the end of write-data so that the write-data comprising a guarantee code becomes an integral multiple of the logical block BLK1. Furthermore, the insertion location of the unused part UP is not limited to the extreme end of the write-data. The byte length of the unused part UP changes in accordance with the length of the write-data sent from the host 20, that is, the value of the basic I/O size BIO.

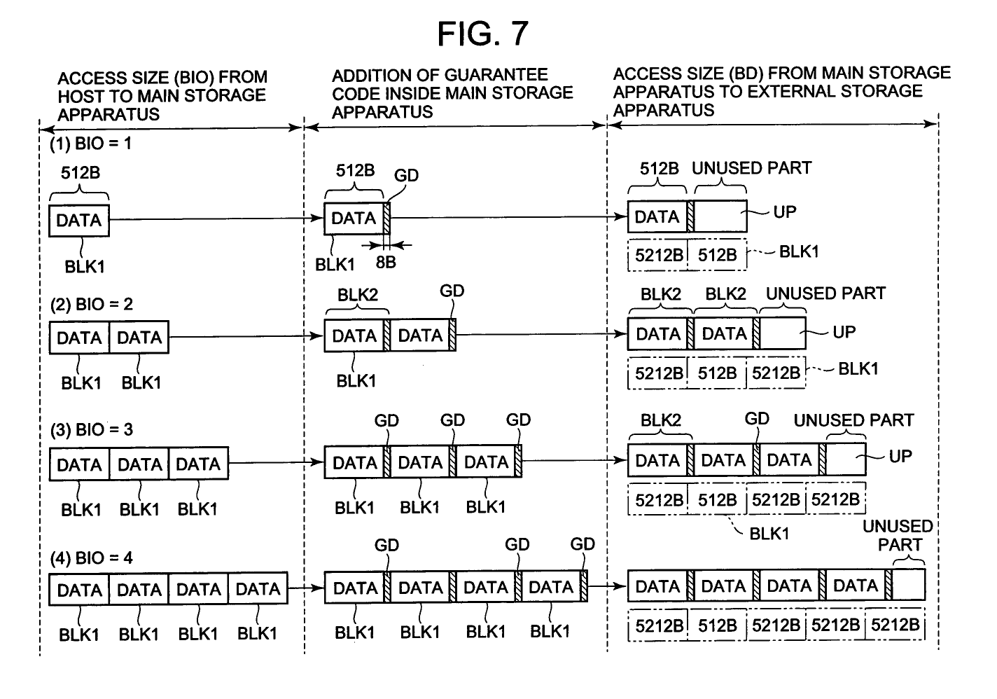

FIG. 7 is a schematic diagram showing the changing proportion of the unused part UP in the write-data. As shown in FIG. 7 (1), when the basic I/O size BIO is constituted by just one logical block BLK1, the write-data sent to the external storage apparatus 30 from the main storage apparatus 10 is constituted from two logical blocks BLK1. In this case, the byte length of the unused part UP is 504 (=512×2−(512+8)) bytes. The proportion of the unused part UP in the write-data received by the external storage apparatus 30 is approximately 49% (=504/1024).

As shown in FIG. 7 (2), when the basic I/O size BIO is constituted from 2 logical blocks BLK1, the external storage apparatus 30 receives from the main storage apparatus 10 write-data having a length of three logical blocks. In this case, the byte length of the unused part UP is 496 (=512×3−(512×2+8×2)). The proportion of the unused part UP comprising the write-data received by the external storage apparatus 30 is approximately 32%.

As shown in FIG. 7 (3), when the basic I/O size BIO is constituted from 3 logical blocks BLK1, the external storage apparatus 30 receives from the main storage apparatus 10 write-data having a length of four logical blocks. In this case, the byte length of the unused part UP is 488 (=512×4−(512×3+8×3)). The proportion of the unused part UP comprising the write-data received by the external storage apparatus 30 is approximately 24%.

As shown in FIG. 7 (4), when the basic I/O size BIO is constituted from 4 logical blocks BLK1, the external storage apparatus 30 receives from the main storage apparatus 10 write-data having a length of five logical blocks. In this case, the byte length of the unused part UP is 480 (=512×5−(512×4+8×4)). The proportion of the unused part UP comprising the write-data received by the external storage apparatus 30 is approximately 19%.

As a result of the presence of a guarantee code GD appended to each of the respective logical blocks BLK1, the basic disk access size BD is constituted from a number of logical blocks BLK1 that is greater by one than the number of logical blocks BLK1 constituting the basic I/O size BIO. The difference between the total byte length of the respective guarantee codes GD and the byte length of one logical block BLK1 becomes the byte length of the unused part UP. When the total byte length of the respective guarantee codes GD is 512 bytes, the unused part UP is not generated.

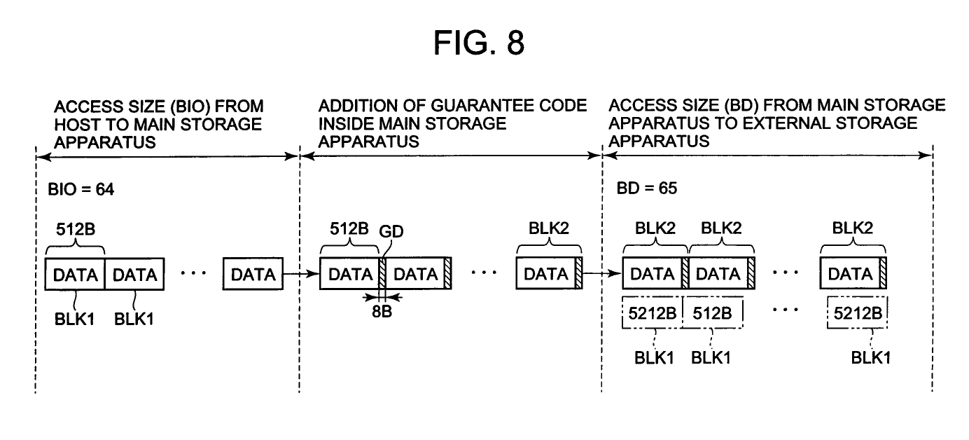

FIG. 8 is a schematic diagram of a situation in which an unused part UP is not generated inside the write-data sent to the external storage apparatus 30 from the main storage apparatus 10.

When the basic I/O size BIO is constituted from 64 logical blocks BLK1, the 64 guarantee codes GD total 512 bytes (64×8=512). In this case, the write-data sent to the external storage apparatus 30 from the main storage apparatus 10 is constituted from 64 logical blocks' BLK1 worth of data, and one logical block's BLK1 worth of guarantee codes GD. Therefore, the basic disk access size BD is constituted from 65 logical blocks BLK1.

That is, if the byte length of the basic I/O size BIO and the byte length of the basic disk access size BD are respectively set to the value (33280) of the lowest common multiple LCM (512, 520) of the 512-byte-length of a logical block BLK1 and the 520-byte-length of an extended logical block BLK2, an unused part UP is not created. Therefore, when the basic I/O size BIO is set as 64 logical blocks BLK1, 64 logical blocks' BLK1 worth of write-data is written to a disk drive 410 inside the external storage apparatus 30 as 65 logical blocks' BLK1 worth of guarantee code-appended data.

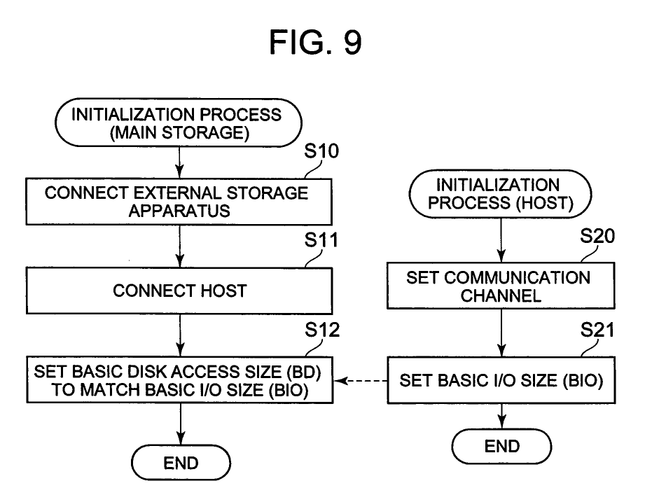

FIG. 9 is a flowchart for carrying out the initialization of the storage system. The respective flowcharts described hereinbelow depict overviews of processes within the scope required to understand and implement the invention, and may differ from an actual computer program. Persons skilled in the art should be able to rearrange the order of the steps, replace a portion of the steps with other steps, and delete a portion of the steps.

A user connects the main storage apparatus 10 to the external storage apparatus 30 via the communication channel CN2, and makes a logical volume 430 inside the external storage apparatus 30 correspondent to a virtual logical volume 230V inside the main storage apparatus 10 (S10). This correspondence task can be carried out via a management terminal 60 operation.

The user connects the main storage apparatus 10 to the host 20 via the communication channel CN1, and sets the logical volumes 230, 230V to be accessed by the host 20. That is, the user utilizes the management terminal 60 to set routing information for the host 20 to access the logical volumes 230, 230V.

The controller 100 of the main storage apparatus 10 sets the basic disk access size BD in accordance with the basic I/O size BIO set in S21 (S12).

Meanwhile, the host 20 sets the routing information for the host 20 to access the main storage apparatus 10 (S20), and, in addition, sets the basic I/O size BIO taking into account the specifications of the application program 21 (S21). For convenience sake, the processing of the main storage apparatus 10 side has been explained as if it is carried out first, but the host 20 settings and the main storage apparatus 10 settings can be carried out approximately in parallel.

Thus, at storage system initialization, the user can set the basic I/O size BIO by taking the circumstances on the host 20 side into account. Then, a value corresponding to this basic I/O size BIO is set in the basic disk access size BD.

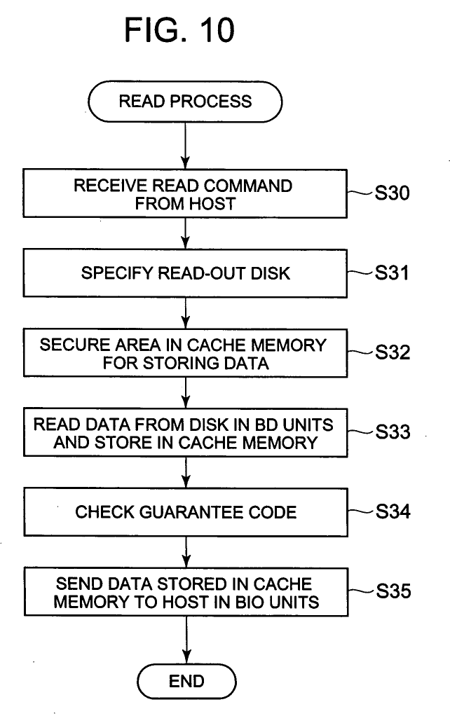

FIG. 10 is a flowchart showing a process in which the main storage apparatus 10 processes a read command issued from the host 20. The main storage apparatus 10 receives the read command issued from the host 20 via the CHA 110 (S30).

The main storage apparatus 10 analyzes the read command, and specifies the logical volume in which the requested data is stored (S31). The main storage apparatus 10 checks the cache memory 130 for an area to store the data (S32).

Next, the main storage apparatus 10 reads out the data from the logical volume specified in S31 in basic disk access size BD units, and stores the read-out data in the cache memory 130 (S33).

As described hereinabove, an unused part UP is generated in accordance with the value of the basic I/O size BIO. That is, in this embodiment, the format of the disk drive 410 (or disk drive 210) is utilized by changing from logical block units to basic disk access size BD units. Because the main storage apparatus 10 uses the configuration information T1 to manage the basic disk access size BD, it is possible to read out data normally from the disk drive 410 (or disk drive 210). That is, the main storage apparatus 10 can distinguish which parts are data, which parts are guarantee codes GD, and which part is the unused part UP.

Now then, the data read to the cache memory 130 in S33 comprises a guarantee code GD. Accordingly, the main storage apparatus 10 examines the contents of the guarantee code GD, and checks if the data read out in S33 is normal data (S34). The main storage apparatus 10 sends the data examined in S34 to the host 20 from the CHA 110 (S35). The guarantee codes GD are removed from the data sent to the host 20 from the main storage apparatus 10.

Furthermore, when the host 20 access destination is a virtual logical volume 230V, the main storage apparatus 10 creates a read command for reading out data from the logical volume 430 inside the external storage apparatus 30, and sends this read command to the external storage apparatus 30. The external storage apparatus 30 reads data from the logical volume 430 in accordance with the read command received from the main storage apparatus 10, and sends this read-out data to the main storage apparatus 10.

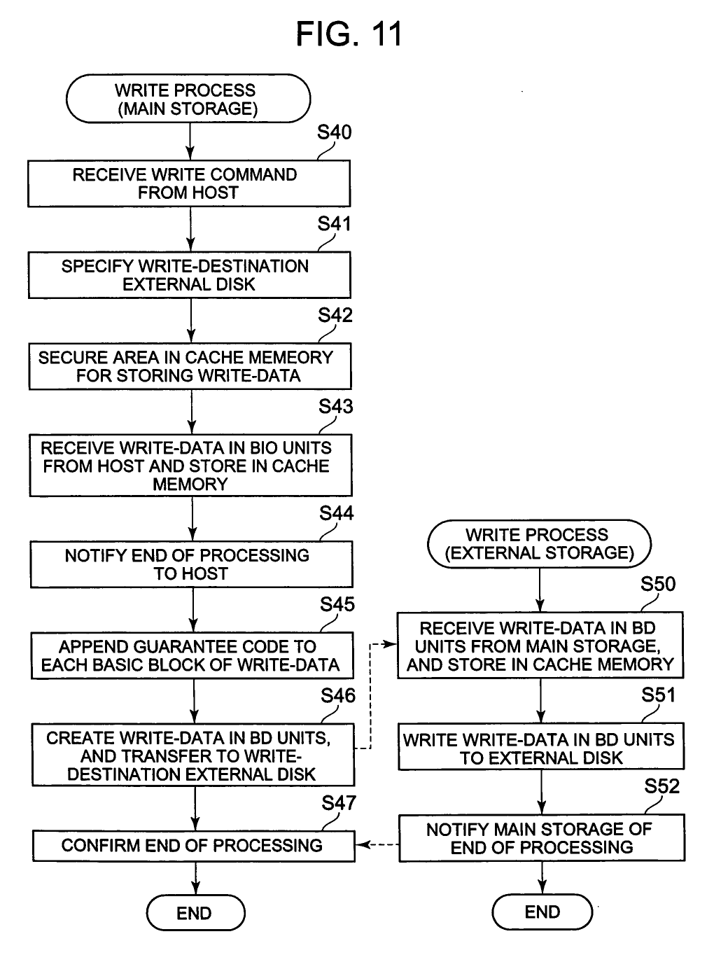

FIG. 11 is a flowchart for processing a write command issued from the host 20. This write process will be explained by giving an example of a situation in which write-data is written to the logical volume (external volume) 430 inside the external storage apparatus 30.

Upon receiving a write command issued from the host 20 (S40), the main storage apparatus 10 analyzes this write command, and specifies the write-targeted external volume 430 (S41). In accordance with an external volume 430 being specified, the disk drive (external disk) 410, which provides the storage area for this external volume 430, is also specified. In the flowchart, the description may not make a special distinction between the external volume 430 and the external disk 410.

The main storage apparatus 10 checks the cache memory 130 for an area to store the write-data (S42). The main storage apparatus 10 receives the write-data from the host 20 in basic I/O size BIO units, and stores this received write-data in the cache memory 130 (S43).

The main storage apparatus 10 can report write-end to the host 20 when the write-data is stored in the cache memory 130 (S44). Or, the main storage apparatus 10 can report write-end to the host 20 subsequent to receiving a write-end report from the external storage apparatus 30. Either method can be employed.

The main storage apparatus 10 creates a guarantee code GD for each of the respective logical blocks BLK1 of the write-data received from the host 20, and appends the respective created guarantee codes GD to the respective logical blocks BLK1 (S45). The creation of this guarantee code GD, and the addition of a guarantee code GD to a logical block BLK1 can be carried out by either software or hardware inside the CHA 110. Or, the constitution can also be such that a dedicated hardware circuit is provided for executing the creation and addition of guarantee codes.

The main storage apparatus 10 converts write-data to which guarantee codes GD have been appended, that is, the write-data in extended logical block BLK2 units to data of logical block BLK1 units, and sends same to the external storage apparatus 30 (S46). That is, as described hereinabove, the main storage apparatus 10 converts the write-data to which guarantee codes GD have been appended to data of basic disk access size BD units having the size of an integral multiple of a logical block BLK1.

The external storage apparatus 30 stores the write-data received from the main storage apparatus 10 in the cache memory 330 (S50). The external storage apparatus 30 writes the write-data stored in the cache memory 330 to the disk drive 410 constituting the external volume 430 (S51). The external storage apparatus 30 reports write-end to the main storage apparatus 10 after writing the write-data to the disk drive 410 (S52). Consequently, the main storage apparatus 10 confirms that processing by the external storage apparatus 30 has ended (S47).

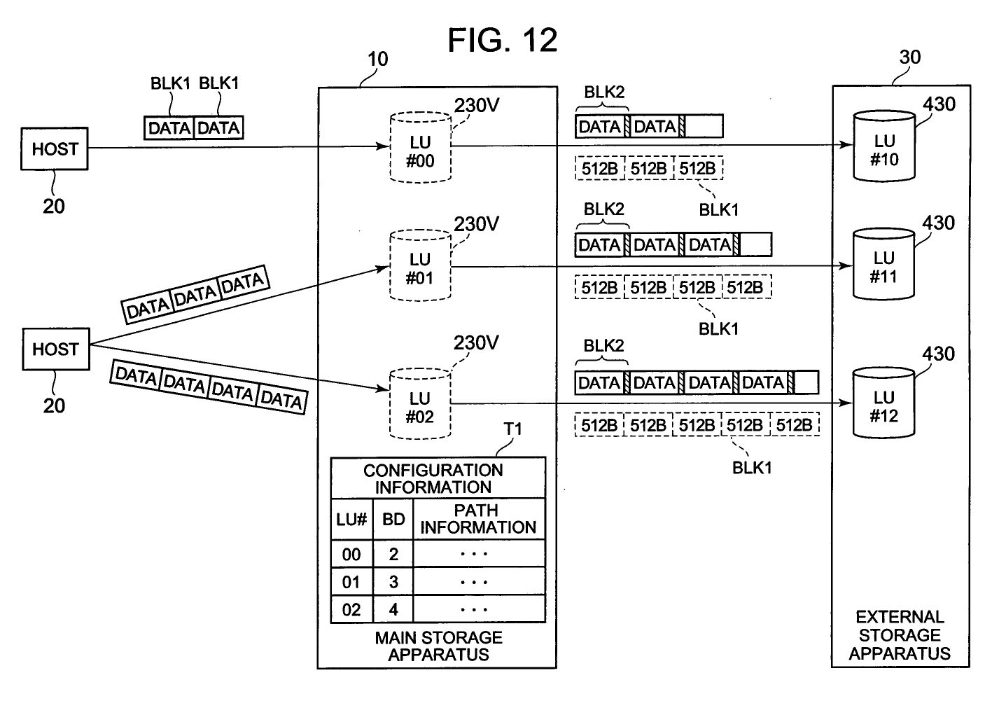

FIG. 12 is a schematic diagram showing a situation in which a different basic I/O size BIO is set for each respective logical volume 230V. As shown in FIG. 12, a different basic disk access size BD can be preset in the configuration information T1 for each logical volume 230V.

For example, the host 20, which utilizes logical volume 230V (#00), accesses two logical blocks BLK1 as the basic I/O size BIO. The main storage apparatus 10 accesses three logical blocks BLK1 as the basic disk access size BD relative to the external volume 430 (#10), which corresponds to the logical volume 230V (#00).

Similarly, the host 20, which utilizes logical volume 230V (#01), accesses three logical blocks BLK1 as the basic I/O size BIO. The main storage apparatus 10 accesses four logical blocks BLK1 as the basic disk access size BD relative to the external volume 430 (#11), which corresponds to the logical volume 230V (#01).

Similarly, the host 20, which utilizes logical volume 230V (#02), accesses four logical blocks BLK1 as the basic I/O size BIO. The main storage apparatus 10 accesses five logical blocks BLK1 as the basic disk access size BD relative to the external volume 430 (#12), which corresponds to the logical volume 230V (#02).

Being constituted as described hereinabove, this embodiment exhibits the following effect. In this embodiment, it is thus possible to store data to which guarantee codes GD have been appended in a disk drive 410 (or a disk drive 210) for which the unit for storing data is fixed at a logical block unit, without reading out data. Therefore, it is possible to curb the degradation of response performance in the main storage apparatus 10, thereby enhancing usability.

In this embodiment, it is possible to set the value of the basic I/O size BIO to a value within a prescribed range that is desirable for the host 20. Therefore, the host 20 is able to send write-data of a desirable size, thereby enhancing usability.

In this embodiment, when the value of the basic I/O size BIO and the value of the basic disk access size BD are set to the lowest common multiple of the byte length of a logical block BLK1 (512 bytes) and the byte length of an extended logical block BLK2 (520 bytes), a disk drive 410 (or a disk drive 210) can be utilized efficiently, making enabling the efficient use of the storage area of a disk drive.

### Second Embodiment

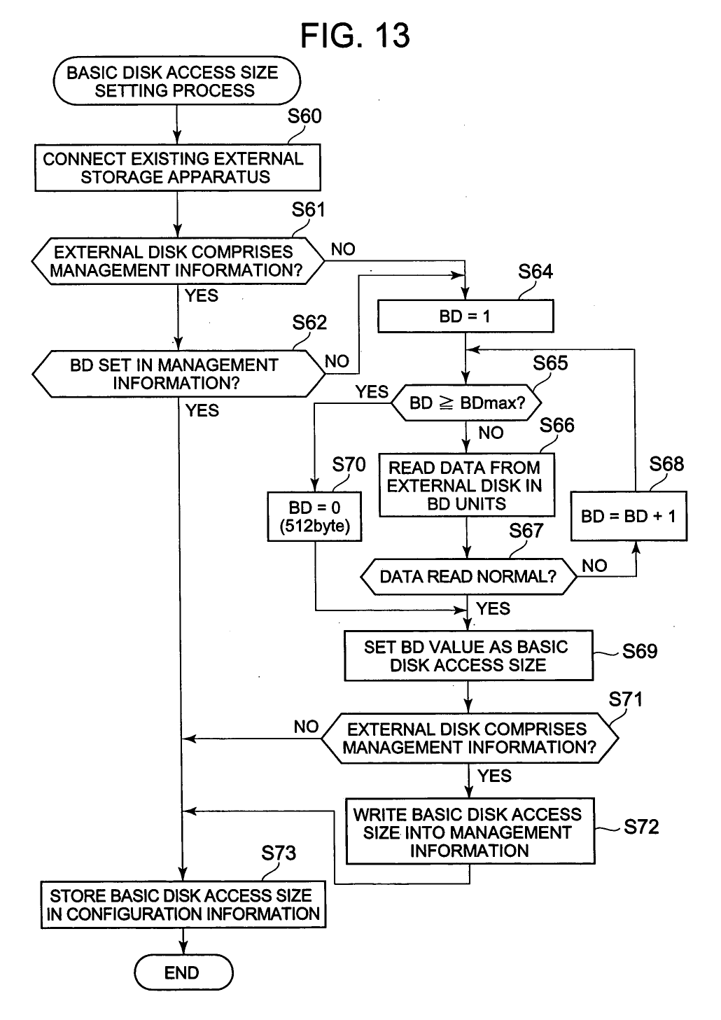

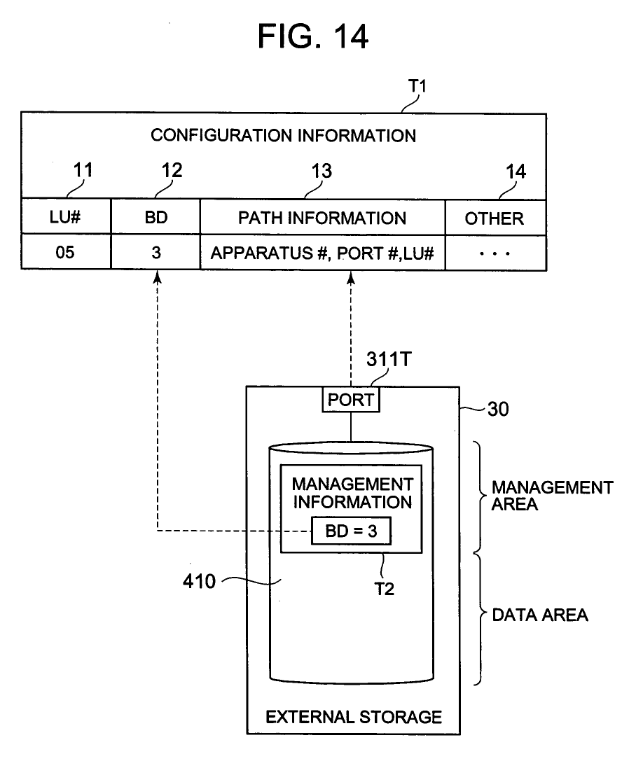

A second embodiment of the present invention will be explained on the basis of FIGS. 13 and 14. The respective embodiments hereinbelow, to include this embodiment, correspond to variations of the first embodiment. In this embodiment, the explanation gives an example of a situation in which an external storage apparatus 30, which is already being used, is connected to the main storage apparatus 10.

As described in the above-mentioned first embodiment, the main storage apparatus 10 comprises a virtualization function, which makes it appear as if an external volume 430 of the external storage apparatus 30 is actually a logical volume 230V inside the main storage apparatus 10. Therefore, a user can utilize an old external storage apparatus 30 via a newly purchased main storage apparatus 10 by using the main storage apparatus 10 to virtualize same. Consequently, a large-capacity cache memory 130 and high-speed microprocessor comprising the main storage apparatus 10 can be used to carry out data input-output processing to an external volume, thereby improving storage system performance.

Thus, thanks to the virtualization function of the main storage apparatus 10, it is possible to effectively utilize an existing external storage apparatus 30. However, in this case, data is most often stored in the external volume 430 in accordance with a prescribed format. For example, when an external storage apparatus 30, which had been previously virtualized by a main storage apparatus 10, is virtualized once again by a different, newly purchased main storage apparatus 10, the respective disk drives 410 constituting the external volume 430 store data in accordance with the previously set basic disk access size BD.

Accordingly, in this embodiment, a situation in which a storage system is constructed based on a basic disk access size BD, which is already set in a disk drive 410 constituting an external volume 430, will be explained.

FIG. 13 is a flowchart showing a process for setting up the basic disk access size BD according to this embodiment. A user connects the main storage apparatus 10 to an existing external storage apparatus 30 (S60).

The main storage apparatus 10 accesses the external storage apparatus 30, and determines if management information T2 is stored in an external disk (that is, a disk drive 410 of the external storage apparatus 30) (S61). The relationship between management information T2 inside a disk drive and configuration information T1 will be explained hereinbelow with FIG. 14.

When the external disk 410 comprises management information T2 (S61: YES), the main storage apparatus 10 determines if the value of the basic disk access size BD is set in this management information T2 (S62).

When the value of the basic disk access size BD is set inside the management information T2 comprised in the external disk 410 (S62: YES), the main storage apparatus 10 registers this basic disk access size BD value in the configuration information T1 (S73). When the basic disk access size BD is already set in the external disk 410, the main storage apparatus 10 continues to use this BD value.

Prior to explaining S64 through S72, the relationship between the management information T2 inside the disk drive and the configuration information T1 will be explained by referring to FIG. 14. The explanation gives a disk drive 410 as an example, but the same also holds true for a disk drive 210 inside the main storage apparatus 10.

The storage area of the disk drive 410 can be broadly divided into a management area and a data area. Management information T2 related to the disk drive 410 is stored in the management area, and write-data is stored in the data area. The value of the basic disk access size BD can be stored in the management information T2.

Therefore, in S62 of FIG. 13, it is possible to check if the value of the basic disk access size BD is set in this disk drive 410 by accessing the management information T2 inside the disk drive 410. The main storage apparatus 10 reads out the value of the basic disk access size BD set in the management information T2 and registers this value in the configuration information T1.

Consequently, when the main storage apparatus 10 accesses this disk drive 410, that is, when the main storage apparatus 10 accesses the logical volume 430, which is created using this disk drive 410, the reading or writing of data is carried out in accordance with the basic disk access size BD already set in this disk drive 410. Thus, by accessing the disk drive 410 using the value of the basic disk access size BD already set in the disk drive 410, the main storage apparatus 10 can read data normally and write data normally.

Returning to FIG. 13, when the disk drive 410 does not comprise management information T2 (S61: NO), or, when the value of the basic disk access size BD is not set in the management information T2 of the disk drive 410 (S62: NO), the value of the basic disk access size BD to be set in this disk drive 410 is checked (S64 through S70). The main storage apparatus 10 checks the BD value by assuming that guarantee code GD-appended data is stored inside the disk drive 410.

The main storage apparatus 10 sets “1” as the initial value of the basic disk access size BD (S64), and determines if the value of the BD set in S64 reaches a prescribed maximum value BDmax (S65).

When the BD value set in S64 does not reach the maximum value BDmax (S65: NO), the main storage apparatus 10 reads data from the disk drive 410 either one time or a plurality of times in succession using the BD value set in S64 (S66). Then, the main storage apparatus 10 determines if it was possible to read data normally in S66 (S67).

For example, consider a situation in which the disk drive 410 stores data in units of three logical blocks BLK1 (BD=3). In this case, if the main storage apparatus 10 reads out data from this disk drive 410 in a logical block unit of less than three logical blocks BLK1 or a logical block unit of four or more logical blocks BLK1, it is not possible for the main storage apparatus 10 to construe this as normal data.

This is because the format (BD value) predicted by the main storage apparatus 10 differs from the format (BD value) of the disk drive 410, and the main storage apparatus 10 is not able to determined which is the data, which is the guarantee codes, and which is the unused part UP. By contrast to this, if the format (BD value) predicted by the main storage apparatus 10 coincides with the BD value of the disk drive 410, the main storage apparatus 10 can distinguish the read-out data normally.

Accordingly, the main storage apparatus 10 repeatedly reads out data from the disk drive 410 (S66) while increasing the value of BD by one each time (S68) until the BD value reaches BDmax (S65), and checks if the data can be distinguished normally (S66).

Furthermore, if it reads out data from the disk drive 410 at a BD value that is smaller than the BD value of the disk drive 410 only one time, there is the possibility that the main storage apparatus 10 can normally distinguish between the data and the guarantee codes GD. Accordingly, in S66, it is desirable to repeatedly read out data from successive storage areas inside the disk drive 410 at the BD value set in either S61 or S68.

When the predicted BD value coincides with the BD value of the disk drive 410, because it is possible to distinguish the data normally (S67: YES), the main storage apparatus 10 selects this predicted BD value as the BD value of this disk drive 410 (S69).

By contrast, when the predicted BD value reaches the BDmax while being increased by one each time (S65: YES), the main storage apparatus 10 sets the BD value to “0” (S70). Here, a BD value of 0 signifies that guarantee code GD-appended data is not stored in this disk drive 410. That is, a disk drive 410 with a BD value of 0 is storing data in 512-byte units to which guarantee codes GD have not been appended.

As explained hereinabove, the main storage apparatus 10 checks the BD value on the premise that data of extended logical block BLK2 units is stored in the disk drive 410 as data of logical block BLK1 units. If the disk drive 410 is storing guarantee code GD-appended data, it is possible to detect the correct BD value set in any disk drive 410.

However, when the disk drive 410 is not storing guarantee code GD-appended data, that is, when the disk drive 410 is storing normal data at a normal size (512 bytes), to which guarantee codes GD have not been appended, it is not possible to detect the BD value via the above-mentioned check (S64 through S69). In this case, it is because a BD value has not been set in the disk drive 410 to begin with. Accordingly, in S70, the BD value of this disk drive 410 is selected as “0”.

By so doing, the unit being used by the disk drive 410 to store data is detected. When this disk drive 410 comprises management information T2 (S71: YES), the main storage apparatus 10 writes the BD value selected in S69 into the management information T2 (S72). Consequently, if the disk drive 410 for which the BD value was written to the management information T2 in S72 is used again by another new main storage apparatus 10 in the future, this other new main storage apparatus 10 will be able to quickly obtain the value of the BD to be used in this disk drive 410 (S61: YES, S62: YES, S73).

Being constituted like this, this embodiment also exhibits the same effect as the above-described first embodiment. In addition to this, in this embodiment, when a disk drive 410 that has already been used is virtually incorporated into a main storage apparatus 10, the main storage apparatus 10 can detect the BD value appropriate for this disk drive 410, and can access this disk drive 410 using this detected BD value. Therefore, user ease-of-use is enhanced.

As described in the first embodiment, the basic I/O size (BIO) is decided in accordance with the circumstances of the host 20, and the basic disk access size BD is selected corresponding to the BIO. Therefore, as long as the circumstances of the host 20 do not change, the BD value related to this disk drive 410 will not change either. That is, even if the main storage apparatus 10 is replaced as the virtualization apparatus, a disk drive 410, which stores data used by a certain application program 21, can be accessed using the same BD value.

### Third Embodiment

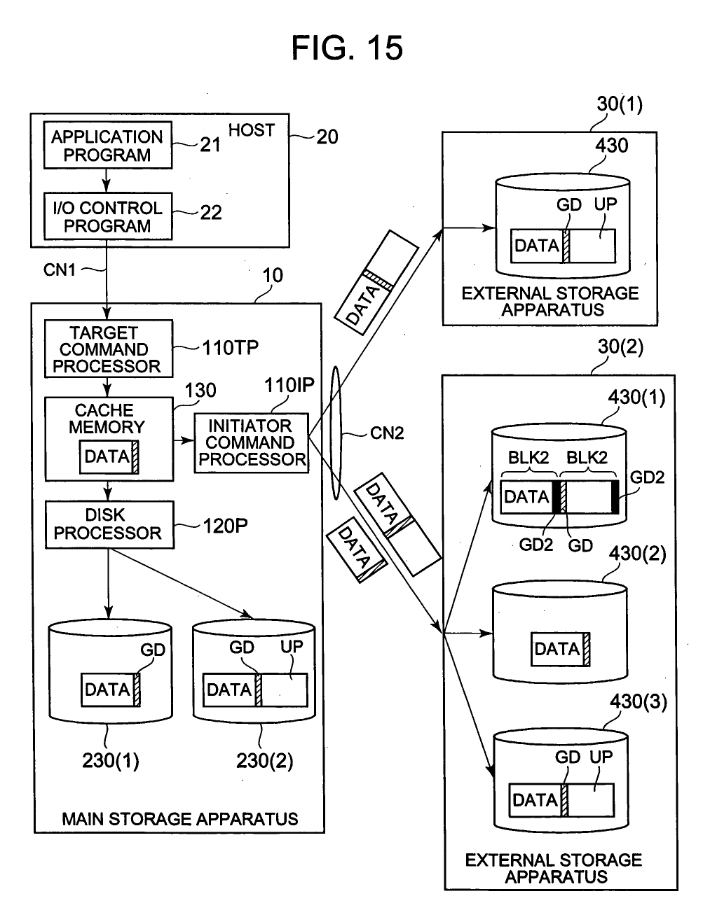

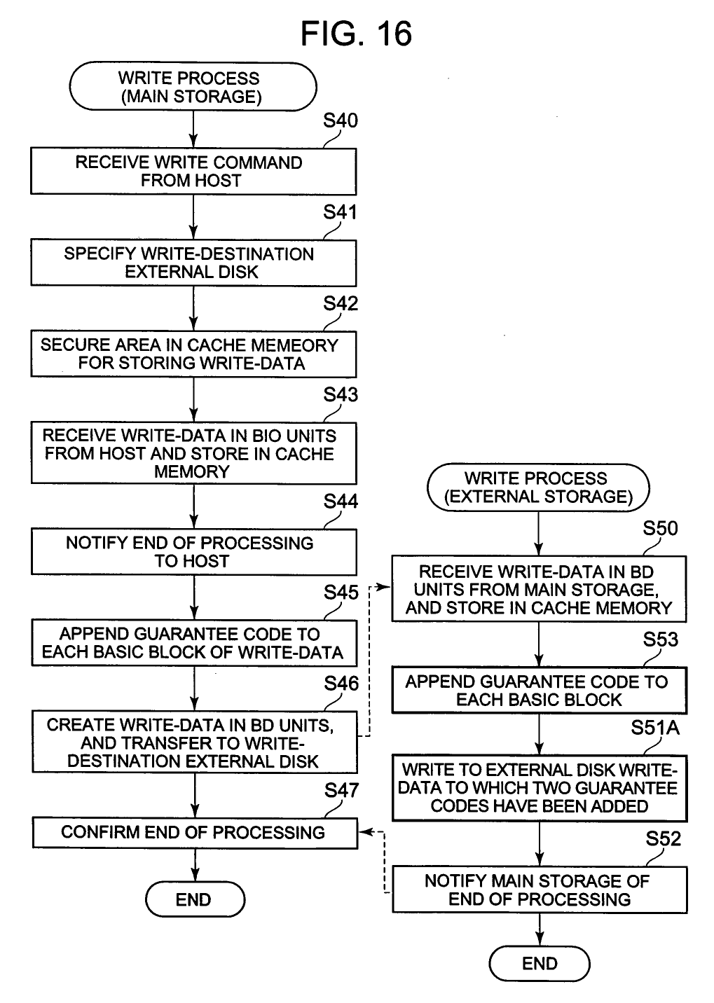

A third embodiment will be explained on the basis of FIGS. 15 and 16. In this embodiment, the storing of write-data in a disk drive 410 inside an external storage apparatus 30 using a plurality of modes will be explained.

FIG. 15 is a schematic diagram showing an overall constitution of a storage system. The storage system of this embodiment comprises a plurality of external storage apparatuses 30 (1), 30 (2). The main storage apparatus 10 appends a guarantee code GD to write-data received from the host 20, and sends same to either of the external storage apparatuses 30 (1), 30 (2) based on a preset mode.

A first external storage apparatus 30 (1), as described in the above-mentioned first embodiment, stores write-data, which comprises a BD's worth of logical blocks BLK1 received from the main storage apparatus 10, inside the logical volume 430 (that is, inside a disk drive 410, which provides a storage area for the logical volume 430). Therefore, the utilization efficiency of the disk drive 410 is degraded by the unused part UP portion. However, data write response performance is improved.

In a second external storage apparatus 30 (2), different modes are used for the respective logical volumes 430 (1) through 430 (3). The respective modes will be explained in order hereinbelow.

In the second external storage apparatus 30 (2), a first mode adds another guarantee code GD2 to guarantee code GD-appended write-data received from the main storage apparatus 10. The second external storage apparatus 30 (2) respectively appends guarantee codes GD2 to each logical block BLK1 of write-data received from the main storage apparatus 10, and stores same inside a disk drive 410. A guarantee code GD2 is appended to each data entity and unused part UP, respectively. Therefore, the external storage apparatus 30 (2) can use the guarantee codes GD2 to check data reliability, and the main storage apparatus 10 can use the guarantee codes GD to check data reliability. Thus, since the guarantee code mechanism is made redundant in the first mode, reliability can be further enhanced.

A second mode stores an extended logical block BLK2 received from the main storage apparatus 10 as-is in a second logical volume 430 (2). The sector length of the disk drive 410, which provides the storage area for the second logical volume 430 (2), is set at 520 bytes. Therefore, the main storage apparatus 10 sends write-data, to which a guarantee code GD has been appended, to the second logical volume 430 (2) in an extended logical block BLK2 unit without converting to a logical block BLK1 unit format. In the second mode, an unused part UP is not generated.

A third mode stores guarantee code-appended write-data received from the main storage apparatus 10 in a third logical volume 430 (3) in logical block BLK1 units as described in the above-mentioned first embodiment and the above-mentioned first external storage apparatus 30 (1).

The focus will be on the main storage apparatus 10 here. The main storage apparatus 10 comprises a plurality of logical volumes 230 (1) and 230 (2). The one logical volume 230 (1) is constituted on the basis of a disk drive 210, which can store data in 520-byte units (in extended logical block BLK2 units). The other logical volume 230 (2) is created on the basis of a disk drive 210, which can store data in 512-byte units (in logical block BLK1 units), the same as described in the above-mentioned first embodiment.

Therefore, data is stored in the disk drive 210 constituting the one logical volume 230 (1) in extended logical block BLK2 units the same as in the above-mentioned second mode. Guarantee code-appended write-data is converted to logical block BLK1 units and stored in the disk drive 210 constituting the other logical volume 230 (2) the same as in the above-mentioned third mode.

FIG. 16 is a flowchart showing the processing when the first mode is applied. FIG. 16 comprises all of steps S40 through S50, and S52 comprising the flowchart of FIG. 11. The FIG. 16 flowchart comprises the new steps S51 and S53.

In S53, guarantee codes GD2 are appended to each respective logical block BLK1 of write-data received from the main storage apparatus 10. Next, the external storage apparatus 30 (2) writes write-data, to which guarantee codes GD and guarantee codes GD2 have been appended, to a disk drive 410 (S51A).

Being constituted like this, this embodiment also exhibits the same effect as the above-described first embodiment. In addition to this, in this embodiment, write-data can be stored inside the same external storage apparatus 30 (2) using a plurality of respectively different modes. Therefore, for example, collectively taking into account the properties of the disk drives 410 (fixed sector or variable sector, sector length of 512 bytes or 520 bytes) and the circumstance of the host 20, makes it possible to select the proper mode, thereby enhancing usability.

### Fourth Embodiment

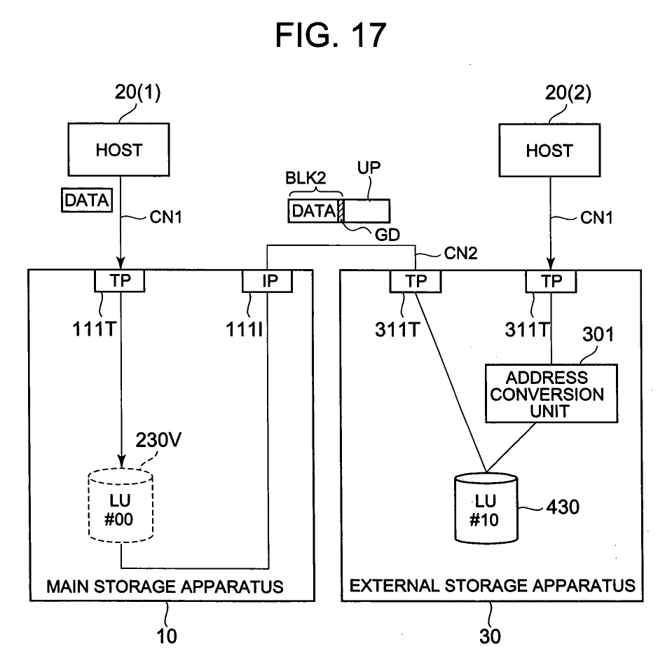

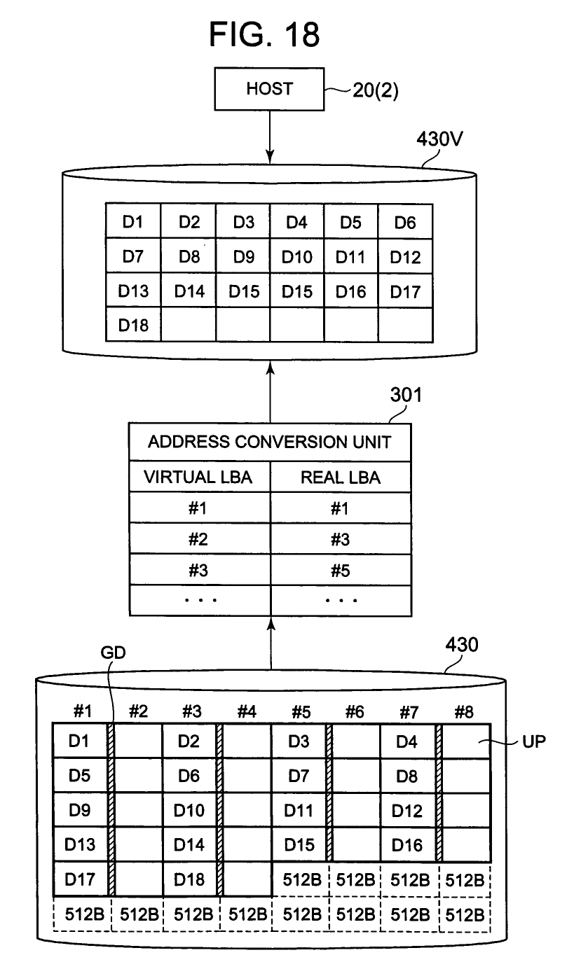

A fourth embodiment will be explained based on FIGS. 17 and 18. In this embodiment, a method is provided for a host 20 to access a logical volume 430 inside an external storage apparatus 30 without going through a main storage apparatus 10.

Guarantee code-appended write-data is stored as data in logical block BLK1 units in a logical volume 430 as described in the above-mentioned first embodiment. That is, an extended logical block BLK2 and unused part UP are stored using a plurality of sectors in the logical volume 430.

The storage system comprises a plurality of hosts 20 (1) and 20 (2). The one host 20 (1) accesses a virtual logical volume 230V based on a preset basic I/O size BIO the same as described in the above-mentioned first embodiment. The virtual logical volume 230V is made correspondent to a logical volume 430 inside the external storage apparatus 30. Write-data received from the host 20 (1) is appended with a guarantee code GD inside the main storage apparatus 10, and is written to a disk drive 410 constituting the logical volume 430.

The other host 20 (2) is connected to a target port 311T of the external storage apparatus 30 via another first communication channel CN1. The other host 20 (2) accesses the logical volume 430 by way of the address conversion unit 301.

FIG. 18 is a diagram schematically showing the constitution of address conversion unit 301 as a “data placement conversion unit”. As explained hereinabove, in addition to the data itself, a guarantee code GD and an unused part UP are also stored in a logical volume 430, which is a real volume. The main storage apparatus 10 determines the storage area of the logical volume 430 in which the data is being stored, and the storage areas in which the unused part UP and guarantee code GD are being stored. Therefore, the host 20 (1) can utilize data inside the logical volume 430 by way of the main storage apparatus 10.

By contrast to this, the host 20 (2), which is directly connected to the external storage apparatus 30, is not able to determine which of the storage areas of the logical volume 430 are being used. Accordingly, the address conversion unit 301 rearranges the data stored in the logical volume 430, and creates a virtual logical volume 430V. The address conversion unit 301 provides the virtual logical volume 430V, in which data is orderly stored in logical block BLK1 units, to the host 20 (2).

The address conversion unit 301, for example, is constituted by making the logical address inside the virtual logical volume 430V (virtual LBA) correspondent to the logical address inside the logical volume 430 (real LBA). For convenience of explanation, FIG. 18 shows a case in which the value of the basic disk access size BD is set as two logical blocks BLK1. In this case, the virtual LBA and real LBA can be made to correspond on a one-to-one basis. If, for example, the value of the basic disk access size BD were to be set at three logical blocks BLK1, 512 bytes of data would be stored across a plurality of sectors. Therefore, it is desirable that the address conversion unit 301, for example, be constituted such that the virtual LBA, real LBA and data length are made correspondent.

Being constituted like this, this embodiment also exhibits the same effect as the first embodiment described hereinabove. In addition to this, in this embodiment, the address conversion unit 301 is provided in the external storage apparatus 30, and a virtual logical volume 430V is created by the address conversion unit 301. Therefore, in this embodiment, the host 20 (2) can access data stored in a logical volume 430 without using the main storage apparatus 10, thereby enhancing usability.

### Fifth Embodiment

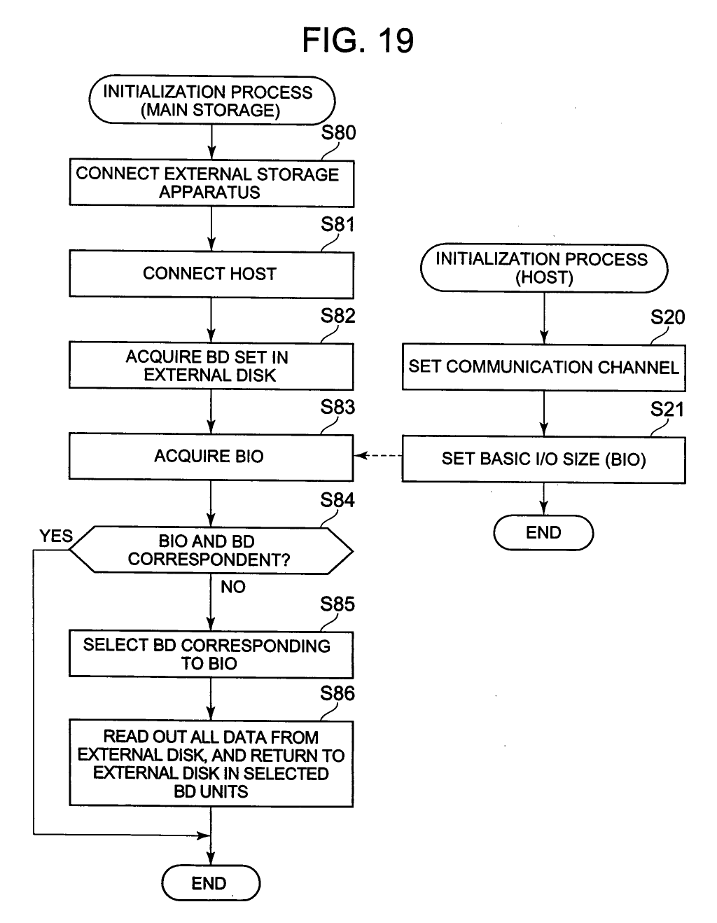

A fifth embodiment will be explained based on FIG. 19. This embodiment overcomes the deficiency that can occur with the second embodiment. In the second embodiment, when a disk drive 410, which is already being used, is connected to the main storage apparatus 10, the BD value set in this existing disk drive 410 is registered in the configuration information T1. Then, when there is no change in the circumstances of the host 20 that is using data stored in this disk drive 410, it was explained that the BD value set in this disk drive 410 can be used without a malfunction occurring.

However, if, for example, the constitution of the application program 21 is updated, and the issuance size of the write-data is changed, there is the likelihood that the basic I/O size BIO preferable for the host 20 and the BD value, which has been set in the disk drive 410, will not correspond.

Accordingly, in the initial setting process shown in FIG. 19, all the data of the existing disk drive 410 is read out, and the format of the existing disk drive 410 is changed in accordance with the value of a new basic disk access size BD selected in accordance with the basic I/O size BIO.

At storage system construction, the main storage apparatus 10 and the external storage apparatus 30 are connected (S80), and the main storage apparatus 10 and the host 20 are connected (S81).

The main storage apparatus 10 accesses the external storage apparatus 30, and acquires the value of the basic disk access size BD, which is stored in the management information T2 of the disk drive 410 (S82). Next, the main storage apparatus 10 acquires the basic I/O size BIO set in the host 20 in S21 (S83). The main storage apparatus 10 determines if the basic disk access size BD acquired in S82 and the basic I/O size BIO acquired in S83 correspond to one another (S84). That is, the main storage apparatus 10 determines if a value corresponding to the value of the basic I/O size BIO is set as the value of the basic disk access size BD. As described in the first embodiment, when the BD value and BIO value properly correspond, the BD value is larger than the BIO value by just one logical block.

When the basic I/O size BIO and basic disk access size BD do not correspond (S84: NO), the main storage apparatus 10 selects a basic disk access size BD that corresponds to the basic I/O size BIO (S85). The main storage apparatus 10 reads out all the data stored in the disk drive 410, and writes this read-out data back to the disk drive 410 in accordance with the BD value selected in S85 (S86). Consequently, data is stored in the disk drive 410 at a BD value that corresponds to a desirable BIO value for the host 20.

Being constituted like this, this embodiment also exhibits the same effect as the first embodiment described hereinabove. In addition to this, in the embodiment, when the BD value set in an existing disk drive 410 does not correspond to the BIO value selected by the host 20, the format of the existing disk drive 410 can be changed to a BD value that corresponds to the BIO value. Therefore, usability is enhanced.

### Sixth Embodiment

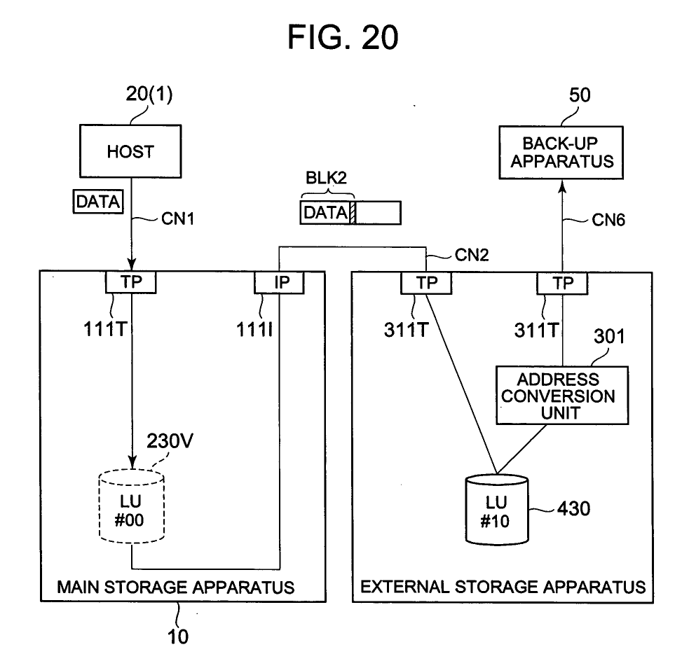

A sixth embodiment will be explained based on FIG. 20. In this embodiment, when backing up data stored in a logical volume 430, a guarantee code GD and unused part UP are removed.

FIG. 20 is a diagram schematically showing an overall constitution of a storage system. A backup device 50 is connected to an external storage apparatus 30 via a communication channel CN6 for backup. The backup device 50, for example, comprises either one or a plurality of recording media, such as a magnetic tape or hard disk. The backup device 50 reads out data stored in a logical volume 430, and stores same in a recording medium.

The address conversion unit 301, as described in the above-mentioned fourth embodiment, creates a virtual logical volume 430V to make it appear as if the data stored in the logical volume 430 is stored in logical block BLK1 units.

The backup device 50 reads out data from the virtual logical volume 430V provided by the address conversion unit 301, and stores the read-out data in the recording medium. Therefore, only the data inside the logical volume 430 is stored in the backup device 50 in a state, in which a guarantee code GD and unused part UP have been removed.

Furthermore, for example, the constitution can also be such that when the backup device 50 comprises a recording medium capable of 520-byte-unit storage, only data and a guarantee code GD are transferred to the backup device 50 from the logical volume 430, and the unused part UP is not transferred. A person having ordinary skill in the art should understand a variation like this, and be readily able to realize same by changing the constitution of the address conversion unit 301.

Being constituted like this, this embodiment also exhibits the same effect as the first embodiment described hereinabove. In addition to this, in this embodiment, it is possible to remove a guarantee code GD and unused part UP, and store only data in a backup device 50 when backing up the contents stored in a logical volume 430. Therefore, the storage medium of the backup device 50 can be effectively utilized, enhancing usability.

Furthermore, the present invention is not limited to the above-described embodiments. A person having ordinary skill in the art can implement various additions and changes within the scope of the present invention. A person having ordinary skill in the art can also appropriately combine the respective embodiments described hereinabove.

What is claimed is:

1. A storage controller which carries out data input/output between a higher-level device and at least one or more storage devices, comprising:
a first communication channel for sending and receiving data with said higher-level device in accordance with a first size which is fixed at a preset value;
a second communication channel for sending and receiving data with said storage device in accordance with a second size which is fixed at a value corresponding to said first size; and
a controller which is connected to said higher-level device via said first communication channel and is connected to said storage device via said second communication channel, and which controls data input/output between said higher-level device and said storage device, this controller comprising at least (1) a write function which converts said first size data received from said higher-level device via said first communication channel to said second size data, sends the converted second size data to said storage device via said second communication channel, and stores same in said storage device, and (2) a read function which converts said second size data read out from said storage device via said second communication channel to said first size data, and sends the converted first size data to said higher-level device via said first communication channel.

2. The storage controller according to claim 1, wherein said first size and said second size can both be indicated as the number of first blocks having a prescribed size,
the number of said first blocks having said first size can be arbitrarily set within a range of between not less than 1 and not more than a prescribed maximum value, and
the number of said first blocks having said second size is set greater by one than the number of said first blocks having said first size by one.

3. The storage controller according to claim 2, wherein, when the number of said first blocks having said first size is set at less than said prescribed maximum value, an unused area is included in the final first block of the plurality of said first blocks having said second size.

4. The storage controller according to claim 2, wherein said prescribed maximum value (Nmax) is set as a value (Nmax=LCM (BS1, BS2)/BS1−1) arrived at by subtracting 1 from a value (LCM (BS1, BS2)/BS1) obtained by dividing the lowest common multiple (LCM (BS1, BS2)) of said prescribed size having said first block (BS1) and of another prescribed size (BS2=BS1+RDS), which appends the data length (RDS) of prescribed redundancy data to said first block, by said prescribed size (BS1).

5. The storage controller according to claim 1, wherein, when a plurality of said storage devices exist, said controller respectively sets said first size and said second size in each of the plurality of storage devices.

6. The storage controller according to claim 1, wherein a data placement conversion unit for providing data stored in second size units in said storage device by converting to placement in which same is stored in first size units is disposed on said storage device side.

7. The storage controller according to claim 1, wherein said controller further comprises a function for storing the value of said second size in a prescribed location inside said storage device.

8. The storage controller according to claim 1, wherein said controller further comprises a function for detecting the value of said second size relative to data stored in said storage device by reading out a prescribed amount of data stored in said storage device while changing the value of the read-out size, and examining contents of the read-out data when said controller and said storage device are connected via said second communication channel.

9. The storage controller according to claim 1, wherein the value of said first size is determined by said higher-level device.

10. The storage controller according to claim 9, wherein the value of said second size is determined by said storage device.

11. The storage controller according to claim 10, wherein, when the value of said first size determined by said higher-level device and the value of said second size determined by said storage device do not correspond, all data stored in said storage device is read out, a value corresponding to the value of said first size determined by said higher-level device is set as the value of said second size, and all of said read-out data is written back to said storage device in the set second size units.

12. The storage controller according to claim 1, wherein said controller can create a second block that is larger in size than said first block for data received from said higher-level device by respectively appending redundancy data of a prescribed length to each preset first block size, and
said controller determines whether said storage device stores data in first block units, or whether said storage device stores data in second block units, (1) when said storage device stores data in said first block unit, sends data of said second size obtained by converting data of said first block size to said storage device using said first block, and (2) when said storage device stores data in said second block unit, sends data of said second size obtained by converting said first size data to said storage device using said second block.

13. A storage system, comprising:
a controller, which is connected to a higher-level device via a first communication channel, and which processes a request from said higher-level device; and
a storage device, which is connected to said controller via a second communication channel, and which is controlled by said controller,
wherein (1) said higher-level device and said controller are set so as to send and receive data by using only a preset first prescribed number of first blocks, which are utilized to send and receive data;
(2) said controller and said storage device are set so as to send and receive data by using a second prescribed number of said first blocks, which is set at a value that is greater by one than said first prescribed number; and
(3) said controller:
(3-1) receives said first prescribed number of said first blocks worth of data via said first communication channel from said higher-level device;
(3-2) appends prescribed redundancy data to said received data for each said first block, and creates data of a second block unit the size of which is larger than said first block;
(3-3) divides the created data of said second block unit into said second prescribed number of first blocks, and stores same; and
(3-4) sends said second prescribed number of first blocks to said storage device via said second communication channel, and stores same in said storage device.

14. The storage system according to claim 13, wherein said higher-level device sets said first prescribed number at a value which is appropriate for said higher-level device.

15. The storage system according to claim 13, wherein a plurality of storage devices are provided as said storage device; and
said second prescribed number can be associated to said plurality of storage devices at respectively different values.
